(19) United States
(12) Patent Application Publication
(10) Pub. No.: US 2026/0149396 A1
(43) Pub. Date: May 28, 2026

(54) Electric Power Generating Apparatus And Method Of Operating Same

(71) Applicant: NovoPower International Inc., Montreal (CA)

(72) Inventors: Camilo José Orrego Caicedo, Montreal (CA); Luis Rodrigues, Montreal (CA); Philip Raphals, Montreal (CA); Tamas Bertényi, Montreal (CA)

(21) Appl. No.: 19/122,825

(22) PCT Filed: Nov. 2, 2023
(86) PCT No.: PCT/CA2023/051463

§ 371 Date: Apr. 21, 2025

Related U.S. Application Data
(60) Provisional application No. 63/421,933, filed on Nov. 2, 2022.

(51) Int. Cl. H02P 9/04; H02K 7/00; H02K 7/18; H02P 9/00; H02P 9/02

(52) U.S. Cl. CPC H02P 9/04; H02K 7/003; H02K 7/1884; H02P 9/009; H02P 9/02; H02K 2213/03

(57) ABSTRACT

There is described an electric power generating apparatus having: a free-piston linear expander having a moving shaft creating mechanical power; an electrical generator converting the mechanical power into electrical power; a variable frequency drive configured for applying an electromagnetic load force modifying the shaft's movement; and a controller communicatively coupled to the variable frequency drive, the controller configured to perform the steps of: receiving sensor data including a first shaft position value, a first shaft velocity value, and a first electromagnetic load force value; using a drive control module, determining, based on the sensor, a second electromagnetic load force value which when applied would cause a shaft velocity to gradually change to a second shaft velocity value, the second electromagnetic load force value and the second shaft velocity value causing an output power value to correspond to a desired output power value; and applying the second electromagnetic load force value.

### FIELD

The improvements generally relate to electric power generating apparatuses and more specifically those incorporating free-piston linear expanders.

### BACKGROUND

Free-piston linear expanders typically use high-pressure or mixed-phase fluid to drive movement of a shaft in back-and-forth sequences along a path. When combined with an electrical generator, mechanical power created by the moving shaft can be converted into electrical power. The typical electrical generator includes a stator consisting of coils winded about the path and a translator having axially magnetized permanent magnets mounted to shaft and moving therewith. In some circumstances, it can be desired to provide a variable frequency drive electromagnetically coupled to the electrical generator. The variable frequency drive can modulate a current in the coils of the electrical generator so as to create a force acting on the translator which can either add to or resist the force imparted to the shaft, thereby instantaneously increasing or decreasing the velocity of movement of the shaft. As such, the velocity of the shaft can be modified in real-time at it moves along the path via the involvement of the variable frequency drive. Although existing techniques to operate an electric power generating apparatuses incorporating free-piston linear expanders were satisfactory to a certain degree, there remains room for improvement.

### SUMMARY

As the output power of such an electric power generating apparatus depends both on the velocity at which the translator moves (hereinafter referred to as “shaft velocity”) relative to the stator and on the current circulating in the coils, the variable frequency drive can influence the output power of the free-piston generator by imparting an electromagnetic load force to the electrical generator, which modifies the trajectory of the shaft. However, due to the complex interactions between force, mass, velocity and power, determining how to modulate the electromagnetic load force in a way which will result in a desired output power value or curve is a challenging problem. This disclosure relates to apparatuses and methods of operating such apparatuses which can enable real-time or quasi real-time control of the actual output power value.

It is known that significant number of parameters can have an impact on the output power value of the apparatus. As such, it was found convenient to use a drive control module to determine, based on sensor data reflecting operating conditions of the electric power generating apparatus, what electromagnetic load force value, which when applied to the electric power generating apparatus would cause a shaft velocity to gradually change to a second shaft velocity value, the electromagnetic load force value and the second shaft velocity value collectively causing an output power value of the electric power generating apparatus to correspond to a desired output power value at a certain moment in time. In some embodiments, the drive control module has been trained using a neural network to provide better performances. In some embodiments, the architecture of the drive control module was selected to be a quadratic neural network which is particularly suited to provide, based on the shaft position, shaft velocity and operating conditions of the electrical generator, a global optimal solution for the immediately future shaft conditions, which is in turn used to calculate the subsequent operating conditions of the apparatus and modify them accordingly in real time.

In accordance with a first aspect of the present disclosure, there is provided an electric power generating apparatus comprising: a free-piston linear expander having a moving shaft creating mechanical power; an electrical generator converting the mechanical power created by movement of the shaft into electrical power; a variable frequency drive coupled to the electrical generator, the variable frequency drive configured for applying an electromagnetic load force u(t) modifying the movement of the shaft and said electrical power; and a controller communicatively coupled to the variable frequency drive, the controller configured to perform the steps of: receiving sensor data reflecting operating conditions of the electric power generating apparatus at a first moment in time tᵢ, the sensor data including a first shaft position value x(tᵢ), a first shaft velocity value v(tᵢ), and a first electromagnetic load force value u(tᵢ); using a drive control module, determining, based on the sensor data at the first moment in time tᵢ, a second electromagnetic load force value u(tᵢ₊₁) which when applied until a second moment in time tᵢ₊₁ would cause a shaft velocity v(t) to gradually change to a second shaft velocity value v(tᵢ₊₁) at the second moment in time tᵢ₊₁, the second electromagnetic load force value u(tᵢ₊₁) and the second shaft velocity value v(tᵢ₊₁) causing an output power value P(tᵢ₊₁) at the second moment in time tᵢ₊₁ to correspond to a desired output power value Pd(tᵢ₊₁); and instructing the variable frequency drive to apply the second electromagnetic load force value u(tᵢ₊₁) until the second moment in time tᵢ₊₁.

Further in accordance with the first aspect of the present disclosure, the drive control module can for example have been trained using a neural network.

Still further in accordance with the first aspect of the present disclosure, the neural network can for example be a quadratic neural network.

Still further in accordance with the first aspect of the present disclosure, a velocity trajectory function or look-up table can for example be pre-determined using a velocity determination module, the velocity determination module can for example associate a plurality of second shaft velocity values v(tᵢ₊₁) to a plurality of combinations of first shaft position values x(tᵢ), first shaft velocity values v(tᵢ), and first electromagnetic load force values u(tᵢ).

Still further in accordance with the first aspect of the present disclosure, the desired output power value Pd(tᵢ₊₁) can for example correspond to a first output power value P(tᵢ) representative of an output power value of the electric power generating apparatus at the first moment in time tᵢ.

Still further in accordance with the first aspect of the present disclosure, the steps of receiving sensor data, determining the second electromagnetic load force value u(tᵢ₊₁) and applying the second electromagnetic load force value u(tᵢ₊₁) can for example be performed after the first moment in time tᵢ and before the second moment in time tᵢ₊₁.

Still further in accordance with the first aspect of the present disclosure, the steps can for example be performed in less than 1 ms, preferably less than 0.5 ms, and most preferably less than 0.1 ms.

Still further in accordance with the first aspect of the present disclosure, the free-piston linear expander can for example have a path, the shaft extending along the path, a piston mounted to the shaft, and a cylinder enclosing the piston and forming a hermetically sealed chamber which upon expansion of pressurized gas contained therein moves the shaft along the path thereby creating the mechanical power.

Still further in accordance with the first aspect of the present disclosure, the electrical generator can for example have a linear electrical generator having a plurality of permanent magnets mounted to the shaft and a plurality of coils magnetically coupled to the plurality of permanent magnets and looped around the shaft.

Still further in accordance with the first aspect of the present disclosure, the electrical generator can for example include a converting device converting the mechanical power of a linear movement of the shaft into rotary movement.

Still further in accordance with the first aspect of the present disclosure, the electrical generator can for example include a rotor mounted to the converting device and a stator magnetically coupled to the rotor.

Still further in accordance with the first aspect of the present disclosure, the electric power generating apparatus can for example further comprise an energy storage device coupled to the electric power generating apparatus, the energy storage device storing electrical power and one of receiving and delivering a portion of said electrical power when required by the controller.

Still further in accordance with the first aspect of the present disclosure, the controller can for example perform said one of said receiving and said delivering upon determining that a difference exists between the desired output power value Pd(tᵢ₊₁) at the second moment in time tᵢ₊₁ and the output power value of the electric power generating apparatus at the second moment in time tᵢ₊₁.

In accordance with a second aspect of the present disclosure, there is provided a method of operating an electric power generating apparatus, the electric power generating apparatus having a free-piston linear expander having a moving shaft generating mechanical power, an electrical generator converting the mechanical power into electrical power, a variable frequency drive coupled to the electrical generator and configured for applying an electromagnetic load force u(t) to the electric power generating apparatus, the method comprising: using a controller communicatively coupled to the variable frequency drive, the controller configured to perform the steps of: receiving sensor data reflecting operating conditions of the electric power generating apparatus at a first moment in time tᵢ, the sensor data including a first shaft position value x(tᵢ), a first shaft velocity value v(tᵢ), and a first electromagnetic load force value u(tᵢ); using a drive control module, determining, based on the sensor data at the first moment in time tᵢ, a second electromagnetic load force value u(tᵢ₊₁) which when applied until a second moment in time tᵢ₊₁ would cause a shaft velocity v(tᵢ) to gradually change to a second shaft velocity value v(tᵢ₊₁) at the second moment in time tᵢ₊₁, the second electromagnetic load force value u(tᵢ₊₁) and the second shaft velocity value v(tᵢ₊₁) causing an output power value P(tᵢ₊₁) at the second moment in time tᵢ₊₁ to correspond to a desired output power value Pd(tᵢ₊₁); and instructing the variable frequency drive to apply the second electromagnetic load force value u(tᵢ₊₁) until the second moment in time tᵢ₊₁.

Further in accordance with the second aspect of the present disclosure, the drive control module can for example have been trained using a neural network

Still further in accordance with the second aspect of the present disclosure, the neural network can for example be a quadratic neural network

Still further in accordance with the second aspect of the present disclosure, the desired output power value Pd(tᵢ₊₁) can for example correspond to a first output power value P(tᵢ) representative of an output power value of the electric power generating apparatus at the first moment in time tᵢ.

Still further in accordance with the second aspect of the present disclosure, the steps of receiving sensor data, determining the second electromagnetic load force value u(tᵢ₊₁) and applying the second electromagnetic load force value u(tᵢ₊₁) can for example be performed after the first moment in time tᵢ and before the second moment in time tᵢ₊₁.

In accordance with a third aspect of the present disclosure, there is provided an electric power generating apparatus comprising: a free-piston linear expander having a moving shaft creating mechanical power; an electrical generator converting the mechanical power into electrical power; a variable frequency drive configured for applying an electromagnetic load force modifying a movement of the shaft; and a controller communicatively coupled to the variable frequency drive, the controller configured to perform the steps of: receiving sensor data including a first shaft position value, a first shaft velocity value, and a first electromagnetic load force value; using a drive control module, determining, based on the sensor, a second electromagnetic load force value which when applied would cause a shaft velocity to gradually change to a second shaft velocity value, the second electromagnetic load force value and the second shaft velocity value causing an output power value to correspond to a desired output power value; and applying the second electromagnetic load force value.

Many further features and combinations thereof concerning the present improvements will appear to those skilled in the art following a reading of the instant disclosure.

### DESCRIPTION OF THE FIGURES

In the figures,

FIG. 1 is a block diagram of an example of an electric power generating apparatus, showing a free-piston linear expander, an electrical generator, a variable frequency drive and a controller, in accordance with one or more embodiments;

FIG. 2 is a block diagram of an example of the controller of FIG. 1, showing a drive control module, in accordance with one or more embodiments;

FIG. 3 is a flow chart of an example of a method of operating an electric power generating apparatus, in accordance with one or more embodiments;

FIG. 4 is a schematic view of an example of a computing device of the controller of FIG. 1, in accordance with one or more embodiments;

FIG. 5 is a schematic view of an example of an electric power generating apparatus, showing a free-piston linear expander with a dual-piston configuration, in accordance with one or more embodiments;

FIGS. 6A-6D are schematic views of the free-piston linear expander of FIG. 5 during a forward stroke, showing a first filing phase, an expansion phase, a gas brake phase and a second filing phase, respectively, in accordance with one or more embodiments;

FIG. 7A is a block diagram showing an example of a switching automaton for a forward stroke such as shown in FIGS. 6A-6D and for a return stroke (not shown), in accordance with one or more embodiments;

FIG. 7B is a block diagram showing expansion phases for the forward stroke and the return stroke, in accordance with one or more embodiments;

FIG. 7C is a block diagram of an example of a high-level switching automaton for an electric power generating apparatus, in accordance with one or more embodiments;

FIG. 8 is a block diagram of an example of a quadratic neural network of a velocity determination module, in accordance with one or more embodiments;

FIG. 9 is a block diagram of an example of a velocity determination module, in accordance with one or more embodiments;

FIGS. 10A-10D are graphs showing position, velocity, velocity costate and position costate as a function of time for the expansion phases of a stroke, in accordance with one or more embodiments;

FIG. 11 is a block diagram of another example of a velocity determination module, in accordance with one or more embodiments;

FIGS. 12A-12D are graphs showing mechanical power, velocity, electromagnetic load force and position as a function of time for an example of an electric power generating apparatus under condition C1, in accordance with one or more embodiments;

FIGS. 13A-13D are graphs showing mechanical power, velocity, electromagnetic load force and position as a function of time for an example of an electric power generating apparatus under condition C1, showing switching instants, in accordance with one or more embodiments;

FIGS. 14A-14D are graphs showing mechanical power, velocity, electromagnetic load force and position as a function of time for an example of an electric power generating apparatus under condition C2, in accordance with one or more embodiments;

FIGS. 15A-15D are graphs showing mechanical power, velocity, electromagnetic load force and position as a function of time for an example of an electric power generating apparatus under condition C3, in accordance with one or more embodiments;

FIGS. 16A-16D are graphs showing mechanical power, velocity, electromagnetic load force and position as a function of time for an example of an electric power generating apparatus under condition C7, in accordance with one or more embodiments;

FIGS. 17A-17D are graphs showing mechanical power, velocity, electromagnetic load force and position as a function of time including noise for three experimental controllers, in accordance with one or more embodiments;

FIGS. 18A-18C are graphs showing mechanical power and electrical power for three experimental controllers, in accordance with one or more embodiments;

FIG. 19 is an electrical circuit for an example of an electric power generating apparatus having an energy storage system, in accordance with one or more embodiments;

FIGS. 20A and 20B show electrical power and charge percentage for different embodiments of the electric power generating apparatus operated using the three experimental controllers, showing results with and without the use of the energy storage system of FIG. 19, in accordance with one or more embodiments; and

FIGS. 21A and 21B show electrical power and charge percentage for an exemplary electric power generating apparatus operated using a neural-network based controller, showing results with and without the use of the energy storage system of FIG. 19, in accordance with one or more embodiments.

### DETAILED DESCRIPTION

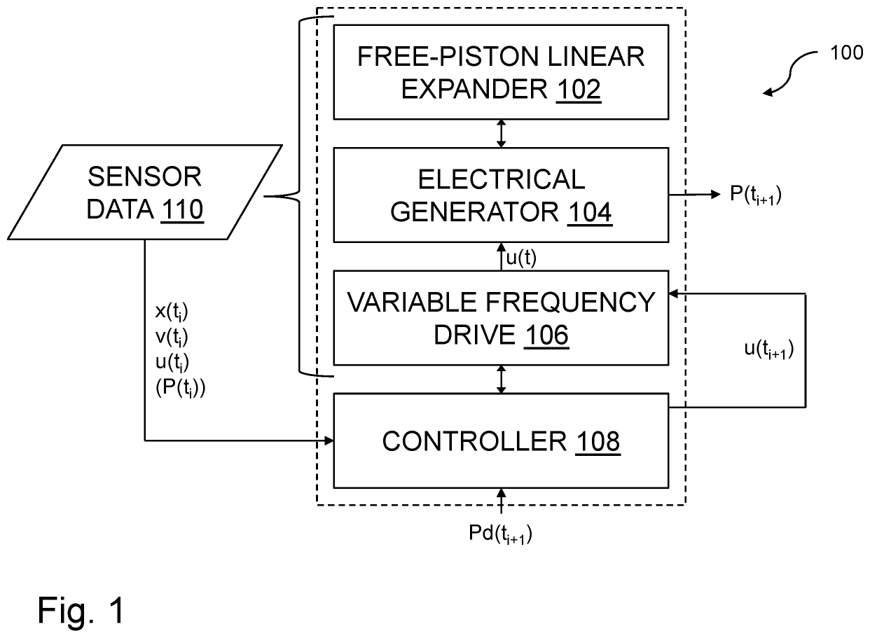

FIG. 1 shows an example of an electric power generating apparatus 100, in accordance with an embodiment. As depicted, the electric power generating apparatus 100 has a free-piston linear expander 102, an electrical generator 104, a variable frequency drive 106 and a controller 108. The free-piston linear expander 102 has a moving shaft creating mechanical power by way of linear movement. The electrical generator 104 converts the mechanical power created by movement of the shaft into electrical power. As shown, the variable frequency drive 106 is coupled to the electrical generator 104 in a way which provides an electrical load to the electrical generator 104. The variable frequency drive 106 is configured for applying an electromagnetic load force u(t) (the variable “t” representing time) modifying the movement of the shaft which in turn modifies the electrical power generated at the electrical generator 104. The controller 108 is communicatively coupled at least with the variable frequency drive 106, however, in some embodiments, the controller 108 is also communicatively coupled to the free-piston linear expander 102 and/or the electrical generator 104 via sensor(s) and/or dedicated controller(s).

During use, the controller 108 is configured for receiving sensor data 110 which reflect operating conditions of the free-piston linear expander 102 and the electric power generating apparatus 100 at a first moment in time tᵢ. In the depicted example, the sensor data 110 include a first shaft position value x(tᵢ), a first shaft velocity value v(tᵢ), and a first electromagnetic load force value u(tᵢ). However, in some other embodiments, other values can be included in the sensor data 110 received at the controller 108. For example, a first output power value P(tᵢ) indicative of the output power P(t) of the electrical generator 104 at the first moment in time tᵢ can be part of the sensor data 110 in some embodiments.

Broadly described, the controller 108 is configured to determine, based on the sensor data 110 at the first moment in time tᵢ, a second electromagnetic load force value u(tᵢ₊₁) which when applied until a second moment in time tᵢ₊₁ would cause a shaft velocity v(t) to gradually change to a second shaft velocity value v(tᵢ₊₁) at the second moment in time tᵢ₊₁. As such, when the second electromagnetic load force value u(tᵢ₊₁) is applied by the variable frequency drive 106 until the second moment in time tᵢ₊₁, the second electromagnetic load force value u(tᵢ₊₁) and the second shaft velocity value v(tᵢ₊₁) together cause an output power value P(tᵢ₊₁) at the second moment in time tᵢ₊₁ to correspond to a desired output power value Pd(tᵢ₊₁).

In other words, based on the shaft velocity v(tᵢ), the shaft position x(tᵢ) and the electromagnetic load force u(tᵢ) at the first moment in time tᵢ, a value for the shaft velocity v(t) at the second moment in time tᵢ₊₁ is first determined. Then, a value for the electromagnetic load force u(t) is determined during a time interval extending between the first moment in time tᵢ and an intermediary moment in time tr which, when applied from the intermediary moment in time t_{i′} until the second moment in time tᵢ₊₁, results in a shaft moving at the shaft velocity v(tᵢ₊₁) at the second moment in time tᵢ₊₁. This latter value, the electromagnetic load force u(t), is implemented by the controller 108 from the intermediary moment in time t_{i′} until the second moment in time tᵢ₊₁ to achieve the desired value of the output power P(t) at the second moment in time tᵢ₊₁. In some embodiments, a velocity trajectory function or look-up table is pre-determined. The velocity trajectory function and look-up table generally associate second shaft velocity values v(tᵢ₊₁) to different combinations of first shaft position values x(tᵢ), first shaft velocity values v(tᵢ), and first electromagnetic load force values u(tᵢ). As such, the determination of the value for the shaft velocity v(t) at the second moment in time tᵢ₊₁ can involve the use of the velocity trajectory function and/or look-up table by inputting the shaft velocity v(tᵢ), the shaft position x(tᵢ) and the electromagnetic load force u(tᵢ) to determine the right shaft velocity v(tᵢ₊₁) at the second moment in time tᵢ₊₁.

In some embodiments, the electric power generating apparatus 100 is operated in a constant output power mode. Accordingly, in these embodiments, the desired output power value Pd(tᵢ₊₁) at the second moment in time tᵢ₊₁ corresponds to the first output power value P(tᵢ) at the first moment in time. By repeating these steps during the movement of the shaft, the output power P(t) of the electric power generating apparatus 100 can be kept constant at least in some phases of the shaft's movement. In some other embodiments, the desired output power value Pd(tᵢ₊₁) is selected based on a desired shaft velocity curve which may or may not be constant over time.

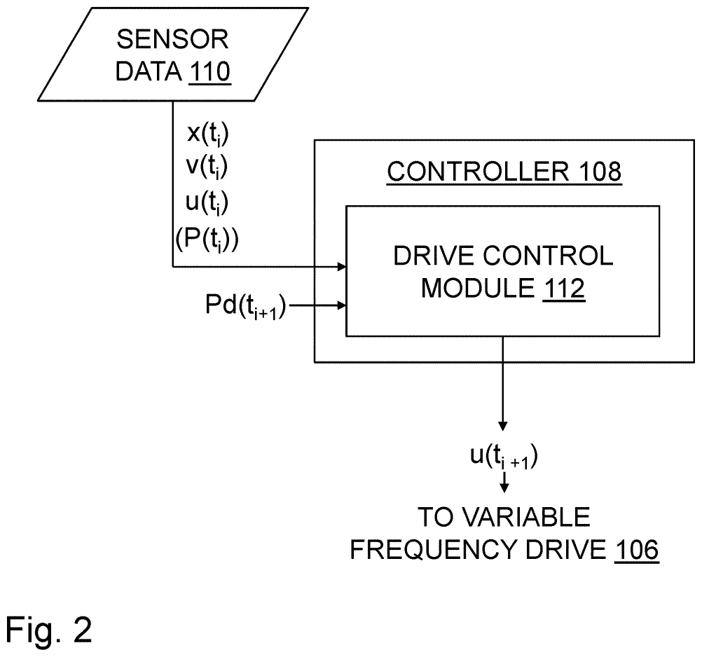

FIG. 2 shows a detailed example of the controller 108. More specifically, the controller 108 has a drive control module 112 communicatively coupled to the variable frequency drive 106. As illustrated, the drive control module 112 receives the sensor data 110 including, but not limited to, the first shaft position value x(tᵢ), the first shaft velocity value v(tᵢ), the first electromagnetic load force value u(tᵢ), the first output power value P(tᵢ), and the like. The drive control module 112 then determines the second electromagnetic load force value u(tᵢ₊₁) which, when applied from an intermediary moment in time t_{i′} causes the shaft velocity to attain by the second moment in time tᵢ₊₁ the second shaft velocity value v(tᵢ₊₁) which, combined with electromagnetic load force value u(tᵢ₊₁), would cause a second output power value P(tᵢ₊₁) to correspond to the desired output power value Pd(tᵢ₊₁) at the second moment in time tᵢ₊₁. The desired output power value Pd(tᵢ₊₁) can be inputted into the controller 108 or be otherwise accessible by the controller 108, depending on the embodiment. After the second electromagnetic load force value u(tᵢ₊₁) has been determined at the intermediary moment in time t_{i′} for instance, the controller 108 instructs the variable frequency drive 106 to apply the second electromagnetic load force value u(tᵢ₊₁) from the intermediary moment in time t_{i′} until time the second moment in time tᵢ₊₁. By doing so, the movement of the shaft is modified to match the second shaft velocity value v(tᵢ₊₁) at the moment in time tᵢ₊₁. As such, the output power outputted by the electric power generating apparatus at the second moment in time tᵢ₊₁ is made to correspond to the desired output power value Pd(tᵢ₊₁). By performing these steps iteratively overtime, the output power P(t) can be controlled in real time or quasi real time.

Referring back to FIG. 1, the free-piston linear expander 102 has a path along which the shaft extends, a piston mounted to the shaft, and a cylinder enclosing the piston and forming a hermetically sealed chamber in which an expanding pressurized gas or mixed-phase fluid moves the shaft along the path, thereby creating the mechanical power. The free-piston linear expander 102 can have any suitable type of configuration including, but not limited to, a single-action piston configuration, with or without a bounce chamber, a double-action piston configuration, and the like. Typically, the piston is moved along the path by way of gas or mixed-phase fluid expanding within one or more hermetically sealed chamber(s). In some embodiments, the expansion of the gas can be caused by high-pressure gas being supplied into the hermetically sealed chamber, which thereafter expands therewithin effectively forcing the piston in a given direction of the path. Additionally or alternatively, the expansion of the gas can be caused by a combustion-like event occurring within the hermetically sealed chamber. Depending on the embodiment, the type of free-piston linear expander 102 used in the electric power generating apparatus 100 can vary.

In some embodiments, the electrical generator 104 is a linear electrical generator. In these embodiments, the linear electrical generator can be provided in the form of a tubular linear permanent magnet synchronous machine. Such machine can have a plurality of permanent magnets mounted to the shaft and one or more coils magnetically coupled to the permanent magnet(s) and looped around the shaft. In some other embodiments, the linear electrical generator has permanent magnets fixed around the path while the shaft moves coils along the path. The electrical generator 104 needs not to be linear in some embodiments. Indeed, in these latter embodiments, the electrical generator has a converting device converting the mechanical power of a linear movement of the shaft into rotary movement using mechanical or hydraulic means. In these cases, the electrical generator can have a rotor mounted to the converting device and a stator magnetically coupled to the rotor. The converting device can be a hydraulic motor driven by hydraulic fluid pressurized by the shaft of the free-piston linear expander, or any other suitable type of converting device.

In some embodiments, the free-piston linear expander 102 and the electrical generator 104 are integrated into a single device. In some embodiments, permanent magnets of the electrical generator can be integrated into the piston of the free-piston linear expander, with the electrical coils integrated into the walls of the cylinder of a single- or double-acting piston-cylinder assembly, with or without a bounce chamber (not shown), such that current is generated in the coils as the piston moves as a result of pressurized vapour being admitted into the cylinder.

The variable frequency drive 106 provides an electrical load to the electrical generator 104 to produce a resistive force opposing the mechanical force produced by the pressurized gas or mixed-phase fluid, i.e., opposing the movement of the piston along the path. In some embodiments, the variable frequency drive 106 converts an alternating-current (AC) output of the electrical generator to direct-current (DC) and then back to AC, at a frequency and voltage set by the controller. In some embodiments, the variable frequency drive 106 can include a grid-tie interface, which allows the power produced by the electric power generating apparatus 100 to be synchronized with and delivered to a local power grid (for example, 50 Hz or 60 Hz public power grid), respecting all regulatory norms in effect. In some embodiments, an electrical emergency brake is provided to stop the piston very rapidly in the event of an electrical or mechanical fault.

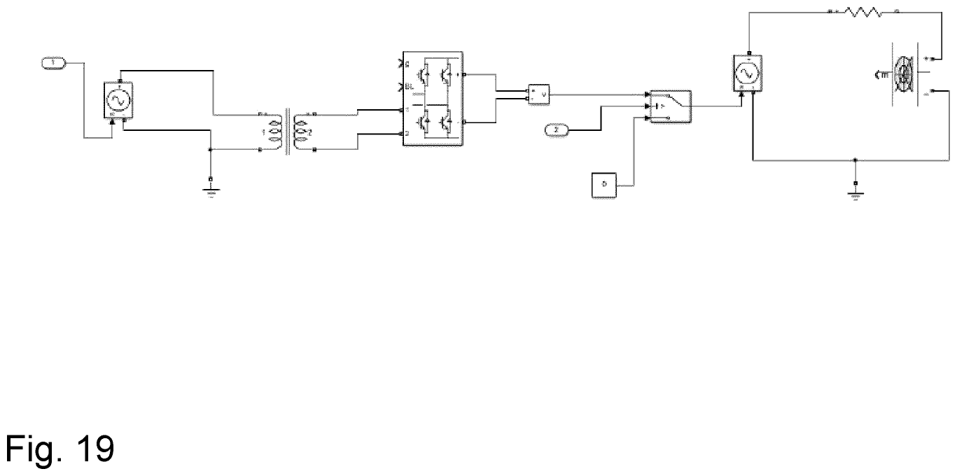

In some embodiments, the electric power generating apparatus 100 has an energy storage device (not shown in FIG. 1) coupled to the electric power generating apparatus 100, to regularize its power output. The energy storage device can draw electrical power from the electric power generating apparatus 100, store the electrical power, and can supply the stored electric power to supplement the power generated by the electric power generating apparatus 100. In some embodiments, the energy storage device can deliver a portion of its electrical power, e.g., when so required by the controller 108. For instance, the controller 108 can perform such a power delivery upon determining that the desired output power value Pd(tᵢ₊₁) at the second moment in time tᵢ₊₁ is greater than the output power value P(tᵢ₊₁) at time tᵢ₊₁. In other words, if the electric power generating apparatus 100 cannot generate a sufficient amount of electrical power, the energy storage device may compensate for the shortfall. In some other instances, the energy storage device can be used to withdraw and store electrical power generated by the electric power generating apparatus 100 when the electricity produced exceeds the desired power output value Pd(t). Such an energy storage device is discussed with reference to FIG. 19 and following.

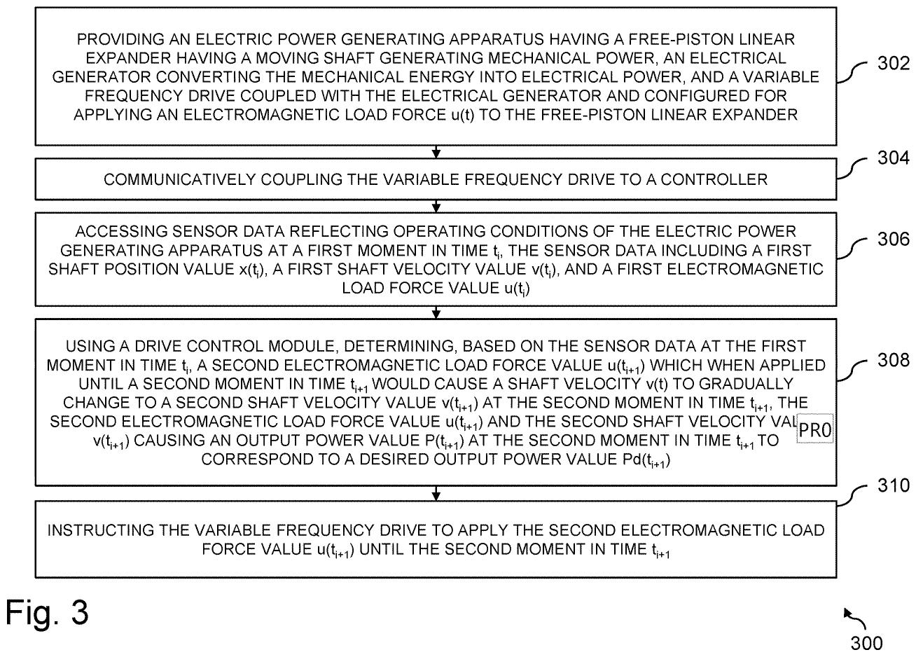

FIG. 3 shows an example of a method 300 of operating an electric power generating apparatus which may be similar in construction to the electric power generating apparatus described with reference to FIG. 1.

At step 302, the method 300 includes a step of providing an electric power generating apparatus. As discussed above, the electric power generating apparatus has a free-piston linear expander having a moving shaft generating mechanical power, an electrical generator converting the mechanical energy into electrical power, and a variable frequency drive coupled with the electrical generator and configured for applying an electromagnetic load force u(t) to the electrical generator.

At step 304, the variable frequency drive is communicatively coupled to the controller. As such, the controller is configured to receive sensor data and to determine the current electromagnetic load force value u(t) to be applied to the variable frequency drive. The communicative coupling can be wired, wireless or a combination of both, depending on the embodiment.

At step 306, sensor data reflecting operating conditions of the electric power generating apparatus at a first moment in time tᵢ are received or otherwise accessed. The sensor data can include, but are not limited to, a first shaft position value x(tᵢ), a first shaft velocity value v(tᵢ), a first electromagnetic load force value u(tᵢ), and/or a first output power value P(tᵢ). The shaft position x(t) can be measured by a position sensor measuring an instantaneous position of the shaft, or a specific marker thereof, along the path. The shaft velocity v(t) can be measured by a velocity sensor measuring an instantaneous velocity of the shaft in some embodiments. Examples of such position and velocity sensors can include, but are not limited to, proximity sensor(s), magnetic sensor(s), optical sensor(s) (e.g., computer vision-based sensor(s)), and radar-based sensor(s), to name a few examples. In some other embodiments, the shaft velocity v(t) is obtained by performing a derivative of the shaft position x(t). The electromagnetic load force u(t) can be reported by the variable frequency drive that applies it. The output power value P(t) can be measured using a power meter measuring an instantaneous output power of the electrical generator. It is noted that when the electrical generator generates power (as opposed to when it motors), the electromagnetic load force resists the movement of the shaft. As discussed in further details below, it is this electromagnetic load force which, when multiplied by a shaft velocity, determines the mechanical power converted into electricity. More specifically, the electromagnetic load force consists of a current in the coils, and the voltage in the coils is determined by the shaft velocity, and hence the power is given by the current times the voltage. As such, the output power value P(t) can be approximated using a calculation involving the shaft velocity v(t) and the electromagnetic load force u(t) using the following equation: P(t)=v(t)·u(t). Other sensor(s) can be used to collect other information pertaining to the free-piston linear expander, the electrical generator and/or the variable frequency drive, all or some of which can be communicatively coupled to the controller.

At step 308, based on the sensor data, the drive control module determines, based on the sensor data accessed at step 306, a second electromagnetic load force value u(tᵢ₊₁) which when applied until a second moment in time tᵢ₊₁ would cause a shaft velocity v(t) to gradually change to a second shaft velocity value v(tᵢ₊₁) at the second moment in time tᵢ₊₁, which when multiplied by the electromagnetic load force value u(tᵢ₊₁) would result in the desired power output Pd(tᵢ₊₁) at the second moment in time tᵢ₊₁. The step 308 can be performed during a time interval extending between the first moment in time tᵢ and an intermediary moment in time t_{i′}. It is intended that the second electromagnetic load force value u(tᵢ₊₁) would modify the movement of the shaft such that the shaft attains the second shaft velocity value v(tᵢ₊₁) at the second moment in time tᵢ₊₁.

At step 310, the controller instructs the variable frequency drive to apply the second electromagnetic load force value u(tᵢ₊₁) until the second moment in time tᵢ₊₁. As discussed above, when applied, the second electromagnetic load force value u(tᵢ₊₁) and the second shaft velocity value v(tᵢ₊₁) collectively cause the output power value P(tᵢ₊₁) at the second moment in time tᵢ₊₁ to correspond to the desired output power value Pd(tᵢ₊₁). As such, the output power P(t) of the electric power generating apparatus can be controlled in real-time or quasi real-time by way of the drive control module.

In some embodiments, the step 306 of receiving the sensor data, the step 308 of determining the second electromagnetic load force value u(tᵢ₊₁) and the step 310 of instructing the controller to apply the second electromagnetic load force value u(tᵢ₊₁) are performed after the first moment in time tᵢ and before the second moment in time tᵢ₊₁. More specifically, these steps can be performed in less than 1 ms, preferably less than 0.5 ms, and most preferably less than 0.1 ms.

In some embodiments, machine learning and/or artificial intelligence can be used to develop functions making it possible for the drive control module to accurately calculate the electromagnetic load force to be applied between the intermediary moment in time t_{i′} and the second moment in time tᵢ₊₁ in order to obtain the desired output power at the second moment in time tᵢ₊₁. In some embodiments, these functions are developed using a neural network. In other embodiments, the neural network used can be a quadratic neural network. It was found that these latter type of neural networks can help providing a global optimal solution for the immediately future shaft conditions, which is in turn used to calculate the subsequent operating conditions of the apparatus and modify them accordingly in real-time or quasi real-time.

The drive control module can be trained using supervised learning. In such supervised learning, each training data (or image) in the set of training data may be associated with a label while training. Supervised machine learning engines can be based on Artificial Neural Networks (ANN), Support Vector Machines (SVM), capsule-based networks, Linear Discriminant Analysis (LDA), classification tree, a combination thereof, and any other suitable supervised machine learning engine. However, in some other embodiments, it is intended that the module can be trained using unsupervised learning where only training data are provided (no desired or truth outputs are given), so as to leave the trained module(s) to find a structure or resemblances in the provided training data. For instance, unsupervised clustering algorithms can be used. Additionally or alternately, the trained module(s) can involve reinforcement learning where the trained module(s) interact with sample training data and when they reach desired or truth outputs, the trained module(s) are provided feedback in terms of rewards or punishments. Two exemplary methods for improving classifier performance include boosting and bagging which involve using several classifiers together to “vote” for a final decision. Combination rules can include voting, decision trees, and linear and nonlinear combinations of classifier outputs. These approaches can also provide the ability to control the trade-off between precision and accuracy through changes in weights or thresholds. These methods can lend themselves to extension to large numbers of localized features. In any case, some of these engines may require human interaction during training, or to initiate the engine, however human interaction may not be required while the engine is being carried out, e.g., during analysis of an accessed data. See Nasrabadi, Nasser M. “Pattern recognition and machine learning.” Journal of electronic imaging 16.4 (2007): 049901 for further detail concerning such trained module(s).

For instance, in some embodiments, a velocity trajectory function or look-up table is pre-determined using a velocity determination module. The velocity trajectory function and/or look-up table generally associate second shaft velocity values v(tᵢ₊₁) to different combinations of first shaft position values x(tᵢ), first shaft velocity values v(tᵢ), and first electromagnetic load force values u(tᵢ). The predetermination of such function or look-up tables allows the controller to efficiently determine, during the operation of the apparatus, the second shaft velocity value v(tᵢ₊₁) based on the sensor data measured or otherwise indicative of the operating conditions of the apparatus at the first moment in time tᵢ. The velocity determination module can also be trained. It is intended that when the training of the module(s) have been performed, then the controller can accurately determine the second shaft velocity v(tᵢ₊₁) and/or the second electromagnetic load force value u(tᵢ₊₁) in real time or quasi real time.

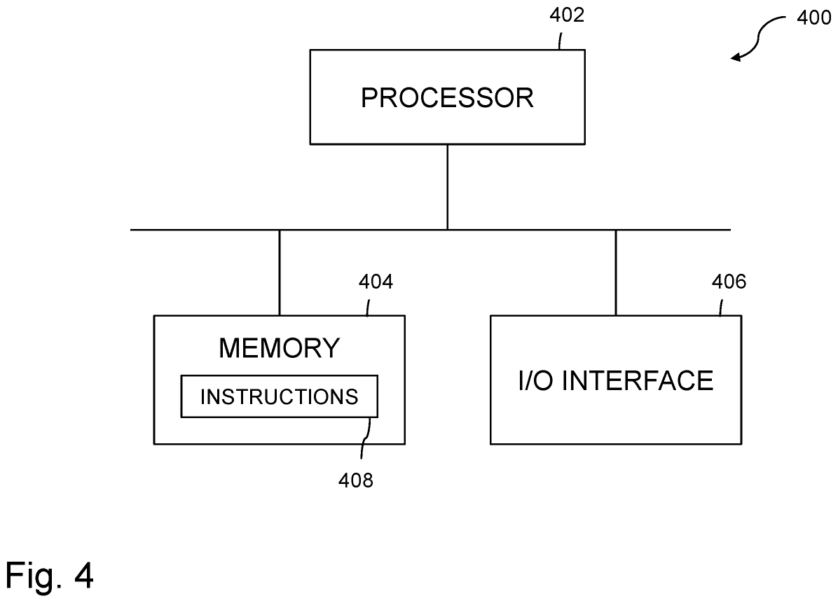

Referring now to FIG. 4, the controller of the electric power generating apparatus of FIG. 1 can be provided as a combination of hardware and software components. The hardware components can be implemented in the form of a computing device 400, an example of which is described with reference to FIG. 4. The computing device 400 can have a processor 402, a memory 404, and I/O interface 406. Instructions 408 for operating the electric power generating apparatus can be stored on the memory 404 and accessed by the processor 402.

The processor 402 can be, for example, a general-purpose microprocessor or microcontroller, a digital signal processing (DSP) processor, an integrated circuit, a field-programmable gate array (FPGA), a reconfigurable processor, a programmable read-only memory (PROM), a programmable logic controller (PLC), or any combination thereof.

The memory 404 can include a suitable combination of any type of computer-readable memory that is located either internally or externally such as, for example, random-access memory (RAM), read-only memory (ROM), compact disc read-only memory (CDROM), electro-optical memory, magneto-optical memory, erasable programmable read-only memory (EPROM), and electrically-erasable programmable read-only memory (EEPROM), Ferroelectric RAM (FRAM) or the like.

Each I/O interface 406 enables the computing device 400 to interconnect with one or more input devices, such as mouse(s), keyboard(s), free-piston linear expanders' sensor(s), electrical generators' sensor(s), or with one or more output devices such as monitor(s), accessible computer-readable memory(ies), the variable frequency drive, and the like.

Each I/O interface 406 enables the controller to communicate with other components, to exchange data with other components, to access and connect to network resources, to server applications, and perform other computing applications by connecting to a network (or multiple networks) capable of carrying data including the Internet, Ethernet, plain old telephone service (POTS) line, public switch telephone network (PSTN), integrated services digital network (ISDN), digital subscriber line (DSL), coaxial cable, fibre optics, satellite, mobile, wireless (e.g. Wi-Fi, WiMAX), SS7 signaling network, fixed line, local area network, wide area network, and others, including any combination of these.

The computing device 400 and any software application that can be ran by the computing device 400 are meant to be examples only. Other suitable embodiments of the controller can also be provided, as it will be apparent to the skilled reader.

### Example 1—Design of a Switched Control System for a Free-Piston Linear Expander

In this example, there is described a switched controller designed so that the power output of a free-piston linear expander is almost constant during a stroke cycle. The control system consists of an open loop system that accelerates the piston, a quadratic neural network controller which maintains the output power constant for most of the non-linear gas expansion process and a state feedback controller that decelerates the piston at the end of the cycle. The quadratic neural network is implemented to predict the dynamics of the system and to determine the required electromagnetic load force for constant power during the isentropic expansion. Its results are compared with two optimal controllers, for continuous time and discrete time models. The focus of the control is on the electromagnetic force and its calculation, leading to the determination of the states and input trajectories that yield the desired value of power. The design of the power electronics drive to generate the force is out of the scope of the example. The additional use of an energy storage system (ESS) reduces the drop of power during the change of stroke. Simulation results show the effectiveness of the proposed methodology.

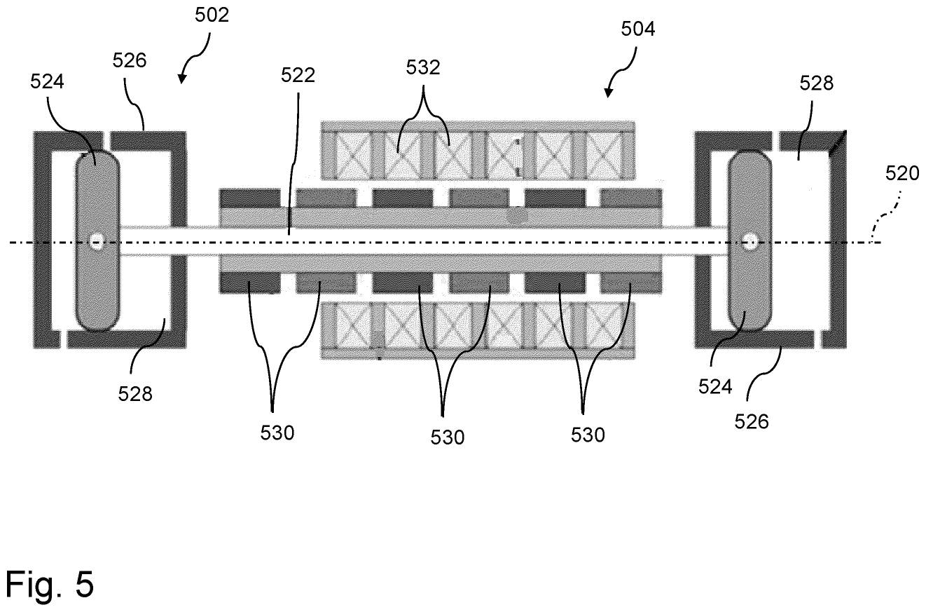

Free-piston linear engines are systems in which the motion of the piston is not restricted by a rotating crankshaft and is determined by the interaction of the forces acting on it. It can have different configurations: simple piston, dual piston, opposed piston and gas generator. The dual piston configuration specifically, consists of three parts: a chamber where high pressure gas enters and expands, a load device that transforms the movement of the piston due to the expansion into a different type of energy, and a rebound chamber that compresses the gas again for the next cycle, in which the piston will move in the opposite direction. The mechanical energy is converted into electrical energy by the use of permanent magnets. This mechanism is considered by some authors as the best option for linear engines due to its high efficiency and high power-to-weight ratio. An example of this engine can be seen in FIG. 5. More specifically, FIG. 5 shows an engine having a free-piston linear generator 502 and an electrical generator 504. In this case, the free-piston linear generator 502 has a double-acting piston-cylinder assembly. As illustrated, the free-piston linear expander 502 has a path 520 along which a shaft 522 extends, pistons 524 mounted to the shaft 522, and cylinders 526 enclosing a corresponding one of the pistons 524. The free-piston linear expander 502 forms hermetically sealed chambers 528 in which an expanding pressurized gas or mixed-phase fluid moves the shaft 522 along the path 520, thereby creating the mechanical power. In this example, the electrical generator 504 is a linear electrical generator more particularly provided in the form of a tubular linear permanent magnet synchronous machine. As depicted, the electrical generator 504 has permanent magnets 530 mounted to the shaft 522 and electrical coils 532 magnetically coupled to the permanent magnets 530 and looped around the shaft 522. In the illustrated, the free-piston linear expander 502 and the electrical generator 504 are integrated into a single device in this example.

The main contributions of this example are:
1. Using the electromagnetic force as a control input to obtain constant power in contrast to the overwhelming literature, which did not focus on constant power.
2. As part of a switched control scheme, a quadratic neural network is designed by the solution of a convex optimization problem to predict a state variable that will be used to control the power output on a free-piston linear expander.
3. The design of an optimal continuous time controller and a model predictive controller that computes the trajectory that minimizes an assigned cost during the isentropic expansion for comparison with the neural network controller.

After the definition of the notation of all the variables that will appear in this example, the dynamics of the piston are derived. The example starts with the determination of the relation between position and pressure in an isentropic expansion, followed by the definition of the dynamics that will generate the movement of the piston and the method to calculate the mechanical power. Based on the latter, the dynamics for a full cycle are determined, including the forward and the return stroke. Lastly, the equations used to determine the electrical power are defined.

The notation used is summarized in Table 1.

TABLE 1
Table showing the nomenclature used in this example

| | |
|---|---|
| $\frac{d}{dt}$ | Derivative |
| U | Total energy |
| p | Pressure |
| v | Volume |
| H | Enthalpy |
| n | Number of moles |
| T | Temperature |
| Cₚ | Heat capacity at constant pressure |
| Cᵥ | Heat capacity at constant volume |
| γ | Heat capacity ratio |
| x | Position of the piston |
| Aₜ | Area of the contact between gas and piston |
| d | Diameter of the piston |
| x₀ | Initial position of the piston |
| v | Velocity of the piston |
| a | Acceleration of the piston |
| m | Mass of the piston |
| Fₑₘ | electromagnetic force |
| F_{gas} | Force of the gas |
| P | Mechanical power |
| P_{d} | Desired mechanical power |
| V | Voltage |
| I | Current |
| R | Resistance |
| L | Inductance |
| P_{elec} | Electrical power |
| C | Capacitance |
| x₁, x₂, x₃ | Switching positions |
| aₙ, bₙ, cₙ, β | Control parameters for the neural network controller |
| q, r | Control parameters for the optimal continuous time controller |
| K | Gains of the state feedback controller |
| W | Noise |

There have been several investigations on the unique features of free-piston linear expanders and how they can be applied to different thermodynamic processes. A common thermodynamic model is the isentropic process, which is both adiabatic and reversible, and for which the entropy remains constant. This model is applied to various idealized processes (such as the Rankine cycle) to obtain an ideal value of the maximum work that is then used as a comparison with the real output of the system.

For a closed system, the total change of energy is equal to the sum of the work done and the heat added. In an isentropic process for which no heat is added, the first law of thermodynamics leads to

$$\frac{dU}{dt} = - p \frac{dv}{dt} \qquad ( 1 )$$

where U is the total internal energy in the system, p is the pressure and v is the volume. Additionally, the change of enthalpy H in a system is given by:

$$\frac{dH}{dt} = \frac{dU}{dt} + p \frac{dv}{dt} + v \frac{dp}{dt} \qquad ( 2 )$$

Replacing (1) in (2), yields:

$$\frac{dH}{dt} = v \frac{dp}{dt} \qquad ( 3 )$$

Moreover, for an ideal gas:

$$\frac{dU}{dt} = {nC}_{v} \frac{dT}{dt} \qquad ( 4 )$$

$$\frac{dH}{dt} = {nC}_{p} \frac{dT}{dt} \qquad ( 5 )$$

where C_p is the heat capacity at constant pressure and C_v is the heat capacity at constant volume. Dividing (5) by (4) and (3) by (1), we get:

$$\frac{{c}_{p}}{{c}_{v}} = γ = \frac{- vdp}{pdv} \qquad ( 6 )$$

where γ is the ratio of specific heats at constant pressure and constant volume. Solving the differential equation (6), with initial conditions, p₀ and v₀ yields:

$${pv}^{γ} = {p}_{0} {v}_{0}^{γ} \qquad ( 7 )$$

The volume of the system is:

$$v = {A}_{t} x \qquad ( 8 )$$

where:

$${A}_{t} = {π ( \frac{d}{2} )}^{2} \qquad ( 9 )$$

Replacing (8) in (7), yields:

$$p = {{p}_{0} ( \frac{{x}_{0}}{x} )}^{γ} \qquad ( 10 )$$

which gives the pressure p at any instant based on the position x of the piston and the initial position of the piston x₀. The position of the piston must be different from zero in all occasion, meaning that the piston must never touch the walls of the chambers.

The forces that are present in the system are the force due to the gas pressure, the electromagnetic force and the friction force, which will be neglected for an isentropic process. The configuration of the free-piston linear generator implies that the movement of the piston is one-dimensional. The equation of motion for this model is:

$$\sum F = m \ddot{x} = {F}_{gas} - {F}_{em} \qquad ( 11 )$$

The gas pressure was found in (10) and the gas force is written as:

$${F}_{gas} = Δ {pA}_{t} = {π ( \frac{d}{2} )}^{2} ( {p}_{A} - {p}_{B} ) \qquad ( 12 )$$

where p_{A} and p_{B} are the pressures in the chambers A and B, respectively (see FIG. 5). The electromagnetic force (Fₑₘ) will be the control input and the output mechanical power is given by:

$$P = {F}_{em} v = {F}_{em} \dot{x} \qquad ( 13 )$$

During the operation of the system, the chambers A and B can be in one of the following 4 phases:
1. Inlet valve A and outlet valve B are open. Outlet valve A and inlet valve B are closed.
2. Outlet valve B is open. Inlet valve A, outlet valve A and inlet valve B are closed.
3. Inlet valve B is open. Inlet valve A, outlet valve A and outlet valve B are closed.
4. Outlet valve A and inlet valve B are open. Inlet valve A and outlet valve B are closed.

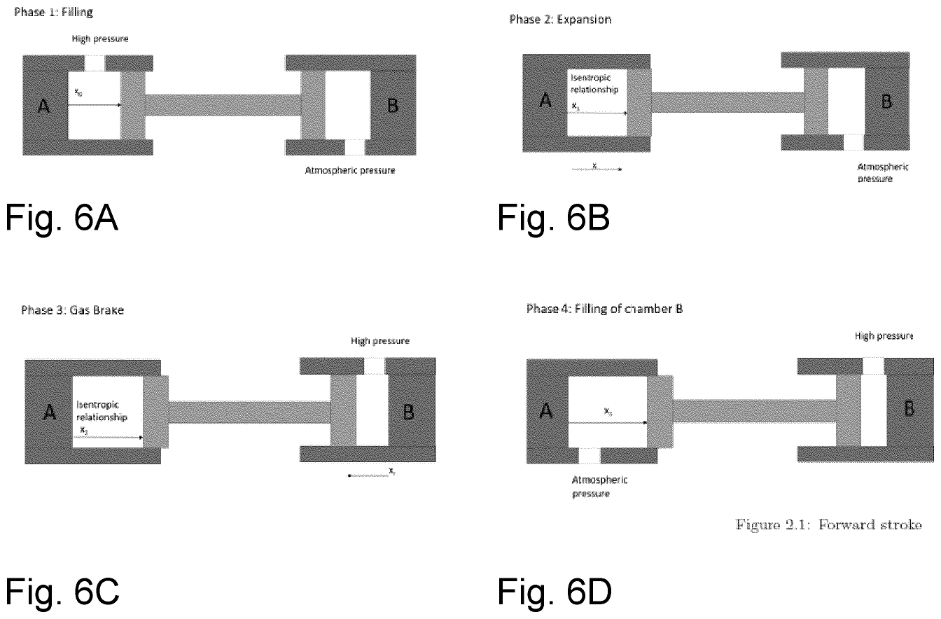

Each phase can be seen in FIGS. 6A-6D

The operation begins with phase 1, where the difference of pressure generates a force that moves the piston toward the chamber with lower pressure. Then, the inlet valve A is closed, creating an isentropic expansion that continues to move the piston. To help slow down the piston, the outlet valve B is closed and its inlet valve is open. This step generates an increase of pressure inside the chamber B, generating a net negative force that reduces the velocity of the piston. The last step is to release the gas from chamber A so the process can be started again but in the opposite direction. The dynamics equations for each phase are:

$$m \ddot{x} = \{ \begin{matrix}{A}_{t} ( {p}_{0} - {p}_{atm} ) - {F}_{em} & phase 1 \\ {A}_{t} ( {{p}_{0} ( \frac{{x}_{1}}{x} )}^{γ} - {p}_{atm} ) - {F}_{em} & phase 2 \\ {A}_{t} ( {{p}_{0} ( \frac{{x}_{1}}{x} )}^{γ} - {p}_{0} ) - {F}_{em} & phase 3 \\ {A}_{t} ( {p}_{atm} - {p}_{0} ) - {F}_{em} & phase 4\end{matrix} \qquad ( 14 )$$

where p₀ is the value of the high pressure and x₁ is the length of chamber A when the inlet valve is closed.

In the return stroke, the equations for the dynamics are:

$$m \ddot{x} = \{ \begin{matrix}{A}_{t} ( {p}_{atm} - {p}_{0} ) + {F}_{em} & phase 1 \\ {A}_{t} ( {p}_{atm} - {{p}_{0} ( \frac{{x}_{1 ret}}{{x}_{r}} )}^{γ} ) + {F}_{em} & phase 2 \\ {A}_{t} ( {p}_{0} - {{p}_{0} ( \frac{{x}_{1 ret}}{{x}_{r}} )}^{γ} ) + {F}_{em} & phase 3 \\ {A}_{t} ( {p}_{0} - {p}_{atm} ) + {F}_{em} & phase 4\end{matrix} \qquad ( 15 )$$

where x₁ᵣₑₜ is the length of chamber B when its inlet valve is closed. To maintain the symmetry of the process, the following constraint must be satisfied:

$${x}_{1 ret} = {x}_{0} + {x}_{f} - {x}_{1} \qquad ( 16 )$$

The mechanical power obtained due to the moving piston will be transformed into electrical power by the use of a three phase tubular permanent magnet linear machine. The q-d equations for a synchronous linear generator are:

$${V}_{q} = {RI}_{q} + \frac{d {Λ}_{q}}{dt} + {Ω}_{s} {Λ}_{d} \qquad ( 17 )$$

$${V}_{d} = {RI}_{d} + \frac{d {Λ}_{d}}{dt} - {Ω}_{s} {Λ}_{q} \qquad ( 18 )$$

$${Λ}_{a} = {L}_{d} {I}_{d} + {Λ}_{PM} \qquad ( 19 )$$

$${Λ}_{q} = {L}_{q} {I}_{q} \qquad ( 20 )$$

$${F}_{e m} = \frac{3 π}{2 τ} ( {Λ}_{PM} {I}_{q} + ( {L}_{d} - {L}_{q} ) {I}_{d} {I}_{q} ) \qquad ( 21 )$$

$${Ω}_{s} = \frac{v π}{τ} \qquad ( 22 )$$

$$v = \dot{x} \qquad ( 23 )$$

$${P}_{elec} = \frac{3 {V}_{q} {I}_{q}}{2} \qquad ( 24 )$$

where V_{d} and V_{q} are the d-axis and q-axis stator voltages, I_{d} and I_{q} are the d-axis and q-axis stator currents, Ωₛ is the electrical frequency, L_{d} and L_{q} are the d-axis and q-axis inductances, Λ_{d} and Λ_{q} are the d-axis and q-axis flux linkages, Λ_{PM} is the constant per-phase magnet flux-linkage, R is the stator resistance and τ is the PM pole pitch. For this type of machine it can be assumed that the current I_{d} is zero, yielding:

$${V}_{q} = {RI}_{q} + \frac{d {Λ}_{q}}{dt} + {Ω}_{s} {Λ}_{P M} \qquad ( 25 )$$

$${V}_{d} = - {Ω}_{s} {Λ}_{q} \qquad ( 26 )$$

$${Λ}_{q} = {L}_{q} {I}_{q} \qquad ( 27 )$$

$${K}_{f} = \frac{3 π}{2 τ} ( {Λ}_{PM} ) \qquad ( 28 )$$

$${F}_{e m} = {K}_{f} {I}_{q} \qquad ( 29 )$$

$${K}_{v} = \frac{{Λ}_{PM} π}{τ} \qquad ( 30 )$$

$${Ω}_{s} {Λ}_{P M} = {K}_{v} v \qquad ( 31 )$$

$${P}_{elec} = \frac{3 {V}_{q} {I}_{q}}{2} \qquad ( 32 )$$

The electromagnetic force is thus controlled by a current I_{q}(t) that passes through a group of coils, generating a magnetic field. This current produces a voltage and therefore, the multiplication of these two values by a factor of

$$\frac{3}{2}$$

due to Park's transformation for three phase power yields the electrical power.

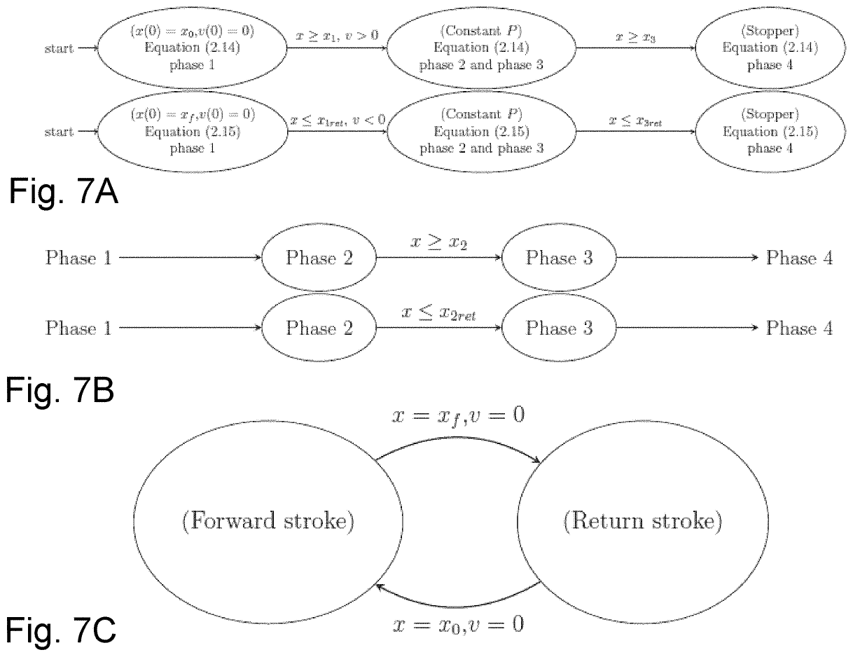

The expansion process in the linear expander involves multiple phases, each one with its distinct dynamics, so a single control system is not the best strategy to achieve the desired objectives (desired constant power and setting the velocity of the piston to zero at the end of each cycle). For example, the stopping of the piston requires a different controller than the one used to maintain constant power. Therefore, a switched controller is implemented. The continuous dynamics of the system are determined by discrete events that will be triggered by reaching a certain value for a continuous state. In phase 1, the system will be open loop because the higher pressure in chamber A will start the motion of the piston without the need for a control input. After this, there will be a controller to maintain constant power in the phases 2 and 3 and finally, a state feedback controller to stop the piston in phase 4. The parameter used to activate the controller switching will be the position of the piston because the gas dynamics are strongly related with the latter, as seen in equations (14). When a certain position is reached, the system automatically changes to a different controller. The control system is then modified so it can be used in the return process. The main difference in the return stroke is that the piston moves in the opposite direction compared with the forward stroke. Due to this, the velocity is negative while in the forward process the velocity is positive. Note that x₃ᵣ is the point at which the return stroke control stopper will be applied. The switching automaton for the proposed controller is depicted in FIG. 7A.

To maintain continuity in the power, the left and right values of the electromagnetic force and the velocity have to be the same at the switching time. The controllers and their activation order will be the following (see FIGS. 6A-6D):
1. In phase 1, the system is in open loop.
2. In phase 2 and phase 3, a controller is used to obtain a constant power based on the nonlinear isentropic expansion process.
3. In phase 4, a state feedback controller is used to decrease the velocity until it reaches zero.

While a single controller will be used to maintain constant power, there are two phases involved, phase 2 and phase 3, and the change between phases is done at the switching position x₂ for the forward stroke or x₂ᵣₑₜ for the return stroke. This is seen in FIG. 7B.

The control for the full cycle combines the controllers used in the forward and the return stroke, as seen in the switching automaton of FIG. 7A. The forward stroke controller works until the piston reaches a defined position (x_{f}). Then, the system changes to the return stroke controller, which is used until the piston reaches another desired position (x₀). FIG. 7C shows a diagram of the higher level switching automaton.

Each phase will now be described in detail. It is important to note that the dynamic equations and the switching positions that are shown are for the forward stroke. For the return stroke, the dynamic equations (15) are used, the constraints on the velocity are modified so that their values are negative, and the switching positions are modified in the following way:

$${x}_{0} \to {x}_{f}$$

$${x}_{1} \to {x}_{1 ret}$$

$${x}_{2} \to {x}_{2 ret}$$

$${x}_{3} \to {x}_{3 ret}$$

$${x}_{f} \to {x}_{0}$$

The proposed controller for phase 2 requires the velocity to be different from zero. Moreover, the electromagnetic force and the power must be continuous at the switching time when the switching position x₁ is reached at the instant tₛ₁. At phase 2, the system will produce a power equal or close to the desired value, therefore it is preferred that the power obtained at the end of phase 1 is also close to the desired value, as seen in ph11,ph12,ph13.

$$x ( {t}_{s 1} ) = {x}_{1} \qquad ( 33 )$$

$$t \to {t}_{s 1}^{-} {F}_{e m} ( t ) {=}^{lim} {t \to {t}_{s 1}^{+} {F}_{em} ( t )}^{lim} \qquad ( 34 )$$

$$t \to {t}_{s 1}^{-} P ( t ) {=}^{lim} {t \to {t}_{s 1}^{+} P ( t )}^{lim} \qquad ( 35 )$$

This is achieved by setting the force to be a linear function of time of the form Fₑₘ(t)=Mt, where M is the slope. In phase 1, the dynamics are linear in Fₑₘ and the gas force is constant, therefore the parameter M can be found using the following system of equations:

### Dynamics

$$a = \frac{{A}_{t} ( {p}_{0} - {p}_{atm} ) - Mt}{m} \qquad ( 36 )$$

$${v}_{f} = {\int }_{0}^{{t}_{f}} adt = \frac{{A}_{t} ( {p}_{0} - {p}_{atm} ) {t}_{f}}{m} - \frac{{Mt}_{f}^{2}}{2 m} \qquad ( 37 )$$

$${x}_{1} = {x}_{0} + {\int }_{0}^{{t}_{f}} {\int }_{0}^{t} a ( τ ) d τ dt \to {x}_{1} - {x}_{0} = \frac{{A}_{t} ( {p}_{0} - {p}_{atm} ) {t}_{f}^{2}}{2 m} - \frac{{Mt}_{f}^{3}}{6 m} \qquad ( 38 )$$

### Constraints

$${v}_{f} = \frac{{P}_{d}}{{Mt}_{f}} \qquad ( 39 )$$

To solve this system, it is requested that F(t_{f})=Mt_{f}. Using this in lindyn1,lindyn2,lindyn3 and rearranging these equations, yield:

$${x}_{1} - {x}_{0} = \frac{{A}_{t} ( {p}_{0} - {p}_{atm} ) {t}_{f}^{2}}{2 m} - F \qquad ( 40 )$$

$${v}_{f} = \frac{{t}_{f} ( 2 {A}_{t} ( {p}_{0} - {p}_{atm} ) - F ( {t}_{f} ) )}{2 m} = \frac{{P}_{d}}{F ( {t}_{f} )}$$

$$⇔ 0 = \frac{{t}_{f} ( 2 {A}_{t} ( {p}_{0} - {p}_{atm} ) - F ( {t}_{f} ) )}{2 m} - \frac{{P}_{d}}{F ( {t}_{f} )} \qquad ( 41 )$$

$$M = \frac{F ( {t}_{f} )}{{t}_{f}} \qquad ( 42 )$$

A solver for the set of nonlinear system composed by (40) and (41) is used to obtain the values of F(t_{f}) and t_{f}. The command fsolve of MATLAB solves this system by applying Newton's method and Powell's dog leg method. The parameter M is found from (42) and v_{f} can be obtained from (41). The values obtained for v_{f} and F(t_{f}) at the end of phase 1 will be used as the initial values of the controller in phase 2.

The proposed controller uses a quadratic neural network to predict the future value of the velocity based on the actual values of the states and the input, and therefore, calculate the value of the input for the next sample time so the constant power is obtained. The results of the controller will be compared with two standard control methods: an optimal continuous time controller and a model predictive controller, which solves an optimal control problem in discrete time.

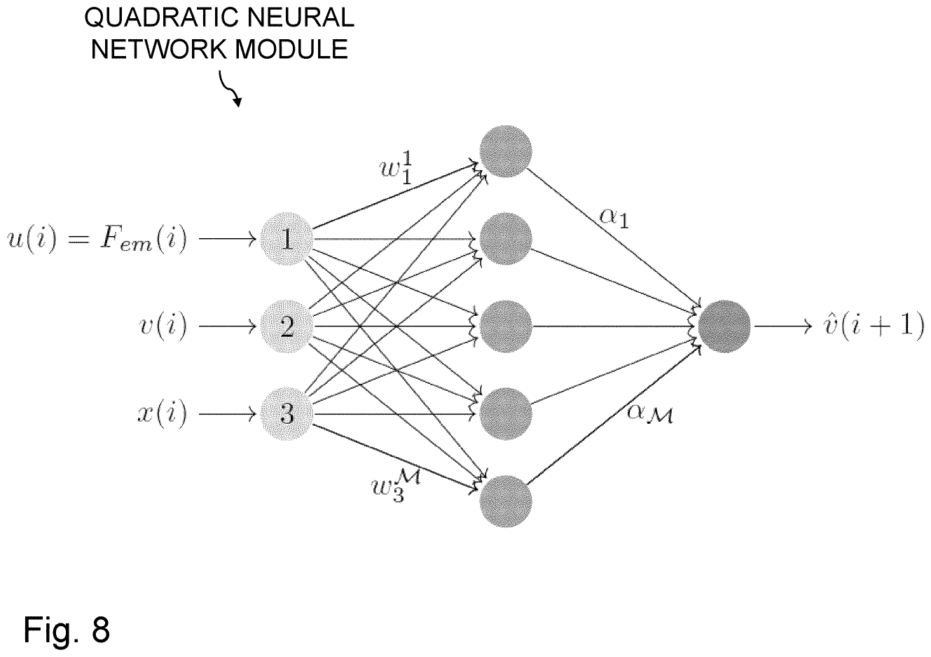

The concept of neural network involves numerous nodes, called neurons, which are connected by edges. There is an input layer and an output layer and between them a series of hidden layers will process the signal received. After the input layer, the value of each neuron is multiplied by a weight, that represents its importance for the following neuron. Then, each neuron in the hidden layers takes the linear combination of values from the previous layer and processes it using an activation function to obtain a result. Each result for each neuron in the hidden layers is assigned another weight, and the next neurons process the linear combination from the previous neurons until it reaches the final output layer. One of the difficulties of designing a neural network is to decide its architecture, which requires a process of trial-and-error. Additionally, the training does not guarantee that the result is the global optimal. A recent contribution in the literature is the use of quadratic neural networks, in which the activation function is a quadratic function. This method addresses the previous drawbacks with conventional neural networks by guaranteeing the global optimal result and determining the architecture of the network. Our purpose is to train the neural network based on an input of data that contains the electromagnetic force, the position and the velocity to predict the velocity in a future instant. The architecture of the neural network is shown in FIG. 8 where M is the number of neurons in the hidden layer, k is the index for the input, and w and α are the weights between the layers. The final output will be determined by:

$$\hat{v} ( i + 1 ) = {\sum }_{j = 1}^{M} σ \qquad ( 43 )$$

where as proposed in reference for system identification:

$$S \qquad ( 44 )$$

$${w}^{j} = \qquad ( 45 )$$

$$σ ( z ) = {a}_{n} {z}^{2} + {b}_{n} z + {c}_{n} \qquad ( 46 )$$

The superscripts indices indicate the target and the subscripts indices indicate the source of each connection. The values of aₙ, bₙ and cₙ were selected using least squares to approximate the function ReLu (z)=max(0,z) between [−5,5].

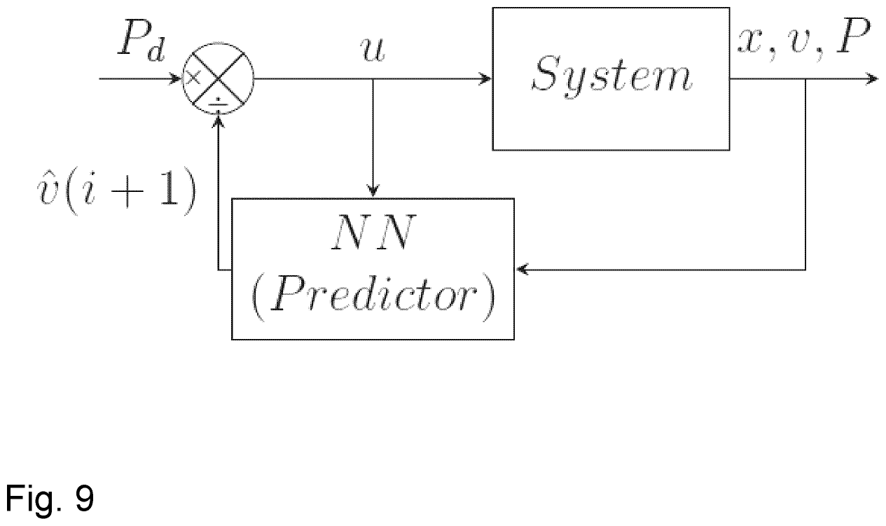

The block diagram for the neural network is in FIG. 9. The training of the neural network will generate the predictor. Based on the current states and input, a predicted value of \hat{v} is obtained and the new value of u is calculated. The cycle is updated until the final position is reached.

The optimization problem defined for the training of the neural network becomes a minimization problem involving a loss function l(.) which evaluates the difference between the real and predicted value for the output, and a regularization term on the 1-norm of the weights α. The formulation is:

$${min}_{{w}^{j} , {a}_{j}} l ( \hat{v} ( i + 1 ) - v ( i + 1 ) ) + β {\sum }_{j = 1}^{M} ⋁ {α}_{j} {⋁}_{1} \qquad ( 47 )$$

$$s . t . \hat{v} ( i + 1 ) = {\sum }_{j = 1}^{M} σ \qquad ( 48 )$$

$$⋁ {w}^{j} {⋁}_{2} = 1 \qquad ( 49 )$$

The dual has the same optimal value of the primal problem (47) and is formulated as:

$${min}_{{Z}^{+ , {Z}^{-} 1 ( \hat{v} ( i + 1 ) - v ( i + 1 ) ) + β}} \qquad ( 50 )$$

$$s . t . \hat{v} ( i + 1 ) = {a}_{n} S \qquad ( 51 )$$

$${Z}_{4}^{+ = T r a c e} \qquad ( 52 )$$

$${Z}^{+ =} \qquad ( 53 )$$

The objective is to find the symmetric matrices Z⁺ and Z⁻ that solve the problem formulated in (50). Then, a matriz Z̅ is obtained by:

$${Z}_{1} = {Z}_{1}^{+ - {Z}_{1}^{- , {Z}_{2} = {Z}_{2}^{+ - {Z}_{2}^{- , {Z}_{4} = {Z}_{4}^{+ - {Z}_{4}^{-}}}}}} \qquad ( 54 )$$

$$\overline{Z} = \qquad ( 55 )$$

Then, the matrix of inputs can be defined as S̅(i)=. With this modification, it is possible to write a quadratic form equivalent to (43) which allows to predict the future value of the velocity based on a quadratic form of the current states and input as:

$$\hat{v} ( i + 1 ) = \overline{S} \qquad ( 56 )$$

The training of the network that will model the system is done with output labels obtained as a response of the system or a simulation of the system (when hardware is not available) to a series of inputs u from a chirp function used in the dynamics of phases 2 and 3. The chirp function is given by the expression:

$$u ( t ) = 650 cos ( \frac{100 π {t}^{2}}{{t}_{f} - {t}_{0}} ) \qquad ( 57 )$$

The following matrices are used to train the network:

$$\hat{S} = [ \begin{matrix}u ( 1 ) & v ( 1 ) & x ( 1 ) & 1 \\ u ( 2 ) & v ( 2 ) & x ( 2 ) & 1 \\ ⋮ & ⋮ & ⋮ & ⋮ \\ u ( N - 1 ) & v ( N - 1 ) & x ( N - 1 ) & 1\end{matrix} ] \qquad ( 58 )$$

$${y}_{out} = {[ \begin{matrix}v ( 2 ) & … & v ( N )\end{matrix} ]}^{T} \qquad ( 59 )$$

where N is the number of data points collected. The matrix Ŝ is defined as the input matrix with the values of input and the states at the present states and the matrix yₒᵤₜ is the output matrix. Choosing the norm infinity of the error as the loss function, the dual formulation for this specific problem yields:

$${min}_{{Z}^{+ , {Z}^{-} ⋁ {\hat{y}}_{out} - {y}_{out} ⋁ ∞ + β}} \qquad ( 60 )$$

$$s . t {Z}_{1} = {Z}_{1}^{+ - {Z}_{1}^{- , {Z}_{2} = {Z}_{2}^{+ - {Z}_{2}^{- , {Z}_{4} = {Z}_{4}^{+ - {Z}_{4}^{-}}}}}} \qquad ( 61 )$$

$$\overline{Z} = \qquad ( 62 )$$

$${\hat{y}}_{out} = {[ \begin{matrix}u ( i ) \\ v ( i ) \\ x ( i ) \\ 1\end{matrix} ]}^{T} \overline{Z} [ \begin{matrix}u ( i ) \\ v ( i ) \\ x ( i ) \\ 1\end{matrix} ] \qquad ( 63 )$$

$${Z}_{4} = Trace ( {Z}_{1} ) \qquad ( 64 )$$

$${Z}^{+ =} \qquad ( 65 )$$

The matrix Z̅ is used to predict the trajectories of x and v yielding:

$$\hat{v} ( i + 1 ) = {[ \begin{matrix}u ( i ) \\ v ( i ) \\ x ( i ) \\ 1\end{matrix} ]}^{T} \overline{Z} [ \begin{matrix}u ( i ) \\ v ( i ) \\ x ( i ) \\ 1\end{matrix} ] \qquad ( 66 )$$

$$u ( i + 1 ) = \frac{{P}_{d}}{\hat{v} ( t + 1 )} \qquad ( 67 )$$

$${t}_{sample} = \frac{{t}_{f} - {t}_{i}}{{N}_{t}} \qquad ( 68 )$$

$$\hat{x} ( i + 1 ) = x ( i ) + \frac{v ( i ) + \hat{v} ( i + 1 )}{2} {t}_{sample} \qquad ( 69 )$$

$$v ( i + 1 ) = \hat{v} ( i + 1 ) , ∀ i \neq 1 \qquad ( 70 )$$

$$x ( i + 1 ) = \hat{x} ( i + 1 ) , ∀ i \neq 1 \qquad ( 71 )$$

where Nₜ represents the number of intervals selected between the initial time t₀ and the final time t_{f}. The value of v is different from zero due to phase 1 and it is assumed that it will remain different from zero. The inputs will be applied to the system in phase 2 and phase 3 and the matrix Z̅ will be used for the two phases.

A controller is designed by solving an optimal control problem with continuous dynamics. To avoid high values of the velocities, it was decided to include a penalty in the value of the velocity energy term of the cost to be minimized. More specifically, the optimal control problem that will be solved in this chapter is:

$${min}_{u , {t}_{f}} {\int }_{{t}_{i}}^{{t}_{f}} {q ( uv - {P}_{d} )}^{2} + {rv}^{2} dt \qquad ( 72 )$$

$$s . t . u = {F}_{em} \qquad ( 73 )$$

$$\dot{x} = v \qquad ( 74 )$$

$$\dot{v} = \frac{{A}_{t} ( {p}_{a} - {p}_{b} ) - u}{m} \qquad ( 75 )$$

$${p}_{a} = {p}_{0} {( \frac{{x}_{1}}{x} )}^{γ} \qquad ( 76 )$$

$${p}_{b} = \{ \begin{matrix}{p}_{atm} & Phase 2 \\ {p}_{0} & Phase 3\end{matrix} \qquad ( 77 )$$

$$x ( 0 ) = {x}_{1} \qquad ( 78 )$$

$$v ( 0 ) = {v}_{f} \qquad ( 79 )$$

where v_{f} is the resultant velocity from above and q and r are positive constants at the discretion of the designer. It is important to remember that the switching positions x₂ and x₃ are set by the designer and that two different optimal control problems will be solved: one with p_{b}=pₐₜₘ for phase 2 and another with p_{b}=p₀ for phase 3. The minimization is done using optimal control theory, more specifically the Pontyagin's minimum principle. This principle says that for an optimization cost.

$$\hat{V} ( x ( t ) ) = Φ ( {x}_{f} , {t}_{f} ) + {\int }_{{t}_{0}}^{{t}_{f}} L ( t , x , u ) dt \qquad ( 80 )$$

the optimal control input u satisfies:

$$H ( t , x , u , λ ) = L ( t , x , u ) + {λ}^{T} f ( t , x , u ) \leq H ( t , x , u , λ ) ∀ u \qquad ( 81 )$$

$$\dot{x} = f ( t , x , u ) \qquad ( 82 )$$

Assuming that H is differentiable, the necessary conditions of optimality are:

$$\dot{λ} = \frac{- \partial H}{\partial x} \qquad ( 83 )$$

$$\frac{\partial H}{\partial u} = 0 \qquad ( 84 )$$

$$\frac{{\partial }^{2} H}{\partial {u}^{2}} \geq 0 \qquad ( 85 )$$

$${λ}_{f} = {[ \frac{\partial Φ}{\partial x} ]}_{{t}_{f}} , {x}_{f} free \qquad ( 86 )$$

$${[ \frac{\partial Φ}{\partial t} + H ]}_{{t}_{f}} = 0 , {t}_{f} free \qquad ( 87 )$$

The Hamiltonian for the problem defined in (72) is:

$$H = {q ( u v - {P}_{d} )}^{2} + r {v}^{2} + {λ}_{v} ( \frac{{A}_{t} ( {p}_{a} - {p}_{b} ) - u}{m} ) + {λ}_{x} v \qquad ( 88 )$$

The solution of the defined problem must satisfy the necessary conditions (83) to (87). Therefore, we have:

$$\frac{\partial H}{\partial u} = 0 = 2 q v ( u v - {P}_{d} ) - \frac{{λ}_{v}}{m} \qquad ( 89 )$$

with the solution:

$$u = \frac{\frac{{λ}_{v}}{2 qmv} + {P}_{d}}{v} \qquad ( 90 )$$

where v is different from zero due to phase 1 and it is assumed to remain different from zero during the phases 2 and 3. The Pontryagin's second order necessary condition is:

$$\frac{{\partial }^{2} H}{\partial {u}^{2}} = 2 q {v}^{2} \geq 0 \qquad ( 91 )$$

The costate Hamilton equations are:

$$- {\dot{λ}}_{v} = \frac{\partial H}{\partial v} = 2 q u ( u v - {P}_{d} ) + 2 r v + {λ}_{x} \qquad ( 92 )$$

$$- {\dot{λ}}_{x} = \frac{\partial H}{\partial x} = \frac{- {A}_{t} {λ}_{ν} {p}_{0} γ {x}_{0}^{γ}}{m {x}^{γ + 1}} \qquad ( 93 )$$

Taking into account that for this problem t_{f} is fixed, the transversality conditions, Pontryagin's principle, Hamilton's equations, and the chain rule lead to:

$$\dot{H} = 0 \qquad ( 94 )$$

$${λ}_{v} ( {t}_{f} ) = 0 \qquad ( 95 )$$

$${λ}_{x} ( {t}_{f} ) = 0 \qquad ( 96 )$$

$$H ( {t}_{f} ) = 0 \qquad ( 97 )$$

Due to (95), the control input from equation (90) approaches

$$\frac{{P}_{d}}{v}$$

as the piston approaches the ending of phase 3. This solution was the inspiration for the algorithm used in the quadratic neural network controller seen in equation (67).

posopt,velopt,optcontx,optcontv,pont7,pont8,pont9,pont10 generate a two-point boundary value problem, as follows:

### Boundary Values

$$x ( 0 ) = {x}_{1} \qquad ( 98 )$$

$$v ( 0 ) = {v}_{f} \qquad ( 99 )$$

$${λ}_{v} ( {t}_{f} ) = 0 \qquad ( 100 )$$

$${λ}_{x} ( {t}_{f} ) = 0 \qquad ( 101 )$$

### Differential Equations

$$\dot{x} = v \qquad ( 102 )$$

$$\dot{v} = \frac{{A}_{t} ( {p}_{a} ( t ) - {p}_{b} ( t ) ) - u ( t )}{m} \qquad ( 103 )$$

$${\dot{λ}}_{v} = - 2 q u ( t ) ( u ( t ) v ( t ) - {P}_{d} ) - 2 r v ( t ) - {λ}_{x} ( t ) \qquad ( 104 )$$

$${\dot{λ}}_{x} = \frac{{A}_{t} {λ}_{ν} ( t ) {p}_{0} γ {x}_{0}^{γ}}{m} \qquad ( 105 )$$

To solve boun1,boun2,boun3,boun4,boun5,boun6,boun7,boun8, the collocation method is used. It consists of approximating the solution of the two-point boundary value problem by a linear combination of piecewise continuous polynomials defined on a mesh of collocation points, such that each state (velocity and position) and costate can be expressed as:

$$x ( t ) = {\sum }_{j = 1}^{{n}_{c}} {ω}_{{x}_{j}} {π}_{{x}_{j}} ( t ) \qquad ( 106 )$$

$$v ( t ) = {\sum }_{j = 1}^{{n}_{c}} {ω}_{{v}_{j}} {π}_{{x}_{v}} ( t ) \qquad ( 107 )$$

$${λ}_{x} ( t ) = {\sum }_{j = 1}^{{n}_{c}} {ω}_{λ {x}_{j}} {π}_{λ {x}_{j}} ( t ) \qquad ( 108 )$$

$${λ}_{x} ( t ) = {\sum }_{j = 1}^{{n}_{c}} {ω}_{λ {v}_{j}} {π}_{λ {v}_{j}} ( t ) \qquad ( 109 )$$

where π represents a spline function, ω represent its coefficient, and n_{c} is the number of collocation points, which are a series of points positioned between the initial and final values of the states and costates.

This set of linear combinations of spline functions must satisfy the following conditions:

$${\sum }_{j = 1}^{{n}_{c}} {ω}_{{x}_{j}} {π}_{{x}_{j}} ( {t}_{0} ) = {x}_{0} \qquad ( 110 )$$

$${\sum }_{j = 1}^{{n}_{c}} {ω}_{{v}_{j}} {π}_{{x}_{v}} ( {t}_{0} ) = {v}_{0} \qquad ( 111 )$$

$${\sum }_{j = 1}^{{n}_{c}} {ω}_{λ {x}_{j}} {π}_{λ {x}_{j}} ( {t}_{f} ) = {λ}_{{x}_{f}} \qquad ( 112 )$$

$${\sum }_{j = 1}^{{n}_{c}} {ω}_{λ {v}_{j}} {π}_{λ {v}_{j}} ( {t}_{f} ) = {λ}_{{v}_{f}} \qquad ( 113 )$$

$$\frac{d}{dt} {\sum }_{j = 1}^{{n}_{c}} {ω}_{{x}_{j}} {π}_{{x}_{j}} ( t ) = v ( t ) \qquad ( 114 )$$

$$\frac{d}{dt} {\sum }_{j = 1}^{{n}_{c}} {ω}_{{v}_{j}} {π}_{{x}_{v}} ( t ) = \frac{{A}_{t} ( {p}_{a} ( t ) - {p}_{b} ( t ) ) - u ( t )}{m} \qquad ( 115 )$$

$$u ( t ) = \frac{\frac{{λ}_{v} ( t )}{2 qmv ( t )} + {P}_{d}}{v ( t )} \qquad ( 116 )$$

$$\frac{d}{dt} {\sum }_{j = 1}^{{n}_{c}} {ω}_{λ {x}_{j}} {π}_{λ {x}_{j}} ( t ) = - 2 q u ( t ) ( u ( t ) v ( t ) - {P}_{d} ) - 2 r v ( t ) - {λ}_{x} ( t ) \qquad ( 117 )$$

$$\frac{d}{dt} {\sum }_{j = 1}^{{n}_{c}} {ω}_{λ {v}_{j}} {π}_{λ {v}_{j}} ( t ) = \frac{{A}_{t} {λ}_{v} ( t ) {p}_{0} γ {x}_{0}^{γ}}{m} \qquad ( 118 )$$

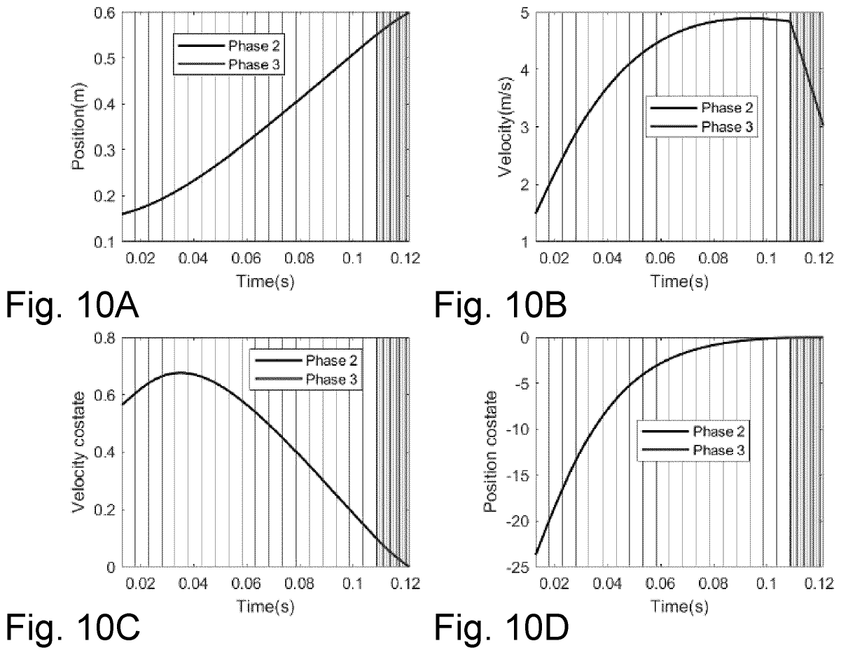

The optimal controller will be used under two different dynamics: phase 2 and phase 3, where the difference is the constant value of the gas pressure in chamber B. Therefore, the collocation method is applied twice. First, it is used in the phase 3 to find the initial costates values for that phase, given that the final costates must be zero. Then, these obtained initial values will be the final values for the collocation method applied for phase 2. The code to implement this procedure is based on the command bvp4c (boundary value problem—4th order) from MATLAB. The results of using the collocation method for boun1,boun2,boun3,boun4,boun5,boun6,boun7,boun8 can be seen in FIGS. 10A-D.

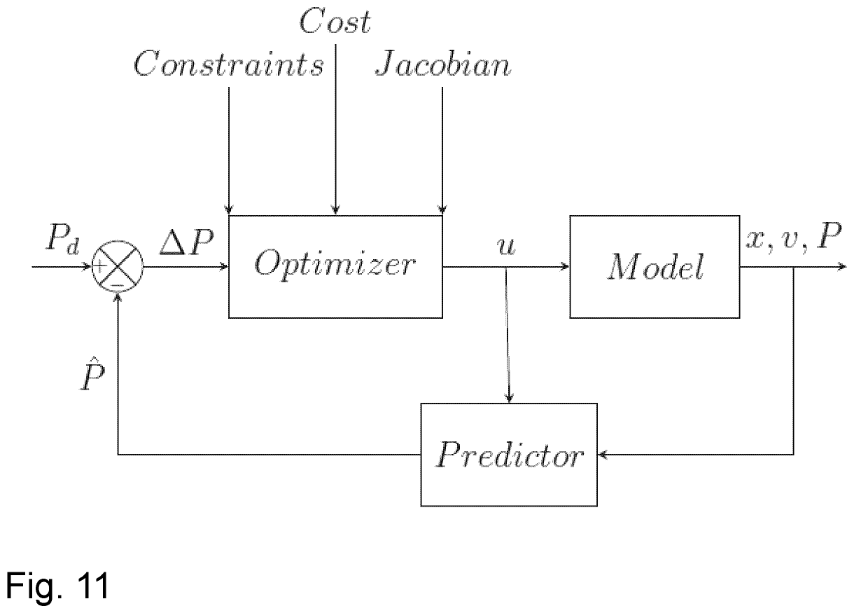

The following paragraphs describe the design of a model predictive controller. In this method, the objective is to find the input that minimizes a cost for a short time horizon. Then, the system will update the next states based on the input for the first-time step and recalculate the new input that minimizes the cost for the same horizon delayed by one time step, until the final time is reached. The input at each step is used to determine the trajectory. In this problem, the decision of predicting only one step into the future was made so that the controller can be compared to the neural network controller. The model predictive control is a widely used and standard control method, so design functions are already available in commercial software. FIG. 11 shows the block diagram for the model predictive controller.

Since the velocity constraints are hard coded in the algorithm, the term rv² of the cost can be omitted in some embodiments. In addition, the model predictive control works in discrete time, so the cost function has to be a discrete sum instead of a continuous integral as it was in (72) yielding the new cost function:

$$J = {\sum }_{t = {t}_{0}}^{{t}_{f}} {( u ( i ) v ( i ) - {P}_{d} )}^{2} \qquad ( 119 )$$

One must discretize the continuous dynamics:

$$\dot{x} = v \qquad ( 120 )$$

$$\dot{v} = \frac{{A}_{t} ( {p}_{a} - {p}_{b} ) - u}{m} \qquad ( 121 )$$

$${p}_{a} = {{p}_{0} ( \frac{{x}_{0}}{x} )}^{γ} \qquad ( 122 )$$

$${p}_{b} = \{ \begin{matrix}{p}_{atm} & Phase 2 \\ {p}_{0} & Phase 3\end{matrix} \qquad ( 123 )$$

and impose the constraints:

$${v}_{f} \leq v \leq 5 \qquad ( 124 )$$

$${x}_{i} \leq x \leq {x}_{l} \qquad ( 125 )$$

$${x}_{i} = \{ \begin{matrix}{x}_{1} & Phase 2 \\ {x}_{2} & Phase 3\end{matrix} \qquad ( 126 )$$

$${x}_{l} = \{ \begin{matrix}{x}_{2} & Phase 2 \\ {x}_{3} & Phase 3\end{matrix} \qquad ( 127 )$$

where v_{f} is the resultant velocity from chapter 1. The sampling time is required if we are working with a continuous time model because the model predictive control works with discrete time dynamics, so a discretization is made. The predictive horizon determines the steps into the future the controller will look into and the control horizon determines the steps in which the calculated input will be implemented. An additional element that can be added to the solver for the PMC problem is the Jacobian of the state model with respect the states and the input. The discretization of the dynamics seen in mmpc1,mmpc2 will be done by the function nlmpc by an implicit trapezoidal rule, which yields:

$$x ( i + 1 ) = x ( i ) + \frac{{t}_{sample} ( v ( i + 1 ) + v ( i ) )}{2} \qquad ( 128 )$$

$$v ( i + 1 ) = v ( i ) + \frac{{t}_{sample} ( a ( i + 1 ) + a ( i ) )}{2} \qquad ( 129 )$$

$$a ( i ) = \frac{{A}_{t} ( {p}_{a} ( i ) - {p}_{b} ) - u ( i )}{m} \qquad ( 130 )$$

$$a ( i + 1 ) = \frac{{A}_{t} ( {p}_{a} ( i + 1 ) - {p}_{b} ) - u ( i + 1 )}{m} \qquad ( 131 )$$

$${p}_{a} ( i ) = {{p}_{0} ( \frac{{x}_{0}}{x ( i )} )}^{γ} \qquad ( 132 )$$

$${p}_{a} ( i + 1 ) = {{p}_{0} ( \frac{{x}_{0}}{x ( i + 1 )} )}^{γ} \qquad ( 133 )$$

$${p}_{b} = \{ \begin{matrix}{p}_{atm} & Phase 2 \\ {p}_{0} & Phase 3\end{matrix} \qquad ( 134 )$$

Additionally, the Jacobian matrices are defined as:

$${J}_{states} = [ \begin{matrix}\frac{\partial \dot{x}}{\partial x} & \frac{\partial \dot{x}}{\partial v} \\ \frac{\partial \dot{v}}{\partial x} & \frac{\partial \dot{v}}{\partial x}\end{matrix} ] \qquad ( 135 )$$

$${J}_{u} = [ \begin{matrix}\frac{\partial \dot{x}}{\partial u} \\ \frac{\partial \dot{v}}{\partial u}\end{matrix} ] \qquad ( 136 )$$

Solving jac1,jac2 yields:

$${J}_{states} = \text{?} \qquad ( 137 )$$

$${J}_{u} = [ \begin{matrix}0 \\ \frac{- 1}{m}\end{matrix} ] \qquad ( 138 )$$

$$\text{?} \text{indicates text missing or illegible when filed}$$

The MPC problem is defined as:

$${min}_{u} J \qquad ( 139 )$$

The functions used to solve this optimal discrete time problem are nlmpc (nonlinear model predictive control) and nlmpcmove from MATLAB. The command nlmpc creates an object that has as input the numbers of states, outputs and inputs of the problem and as properties the sample time, prediction horizon, the control horizon, the model (including the state model, the output and a boolean variable that is active if the function is continuous), the upper and lower bound of the states, the Jacobian matrices for the states and the cost function, all of them defined by the user. The command nlmpcmove calculates the optimal trajectory based on the model, constraints and output defined in the object nlmpc and the initial conditions of the states and the input. The command nlmpcmove uses the command fmincon as default to solve the minimization problem of the cost subject to the model and the constraints using an interior-point method.

To stop the piston, a state feedback controller is designed. The variable Δx is defined as:

$$Δ x = x - {x}_{d} \qquad ( 140 )$$

where x_{d} will be determined later, and the state space representation of phase 4 becomes:

$$[ \begin{matrix}Δ \dot{x} \\ \dot{v}\end{matrix} ] = [ \begin{matrix}0 & 1 \\ 0 & 0\end{matrix} ] [ \begin{matrix}Δ x \\ v\end{matrix} ] + [ \begin{matrix}0 \\ \frac{1}{m}\end{matrix} ] ( {A}_{t} ( {p}_{atm} - {p}_{0} ) - {F}_{em} ) \qquad ( 141 )$$

By designing Fₑₘ to be Fₑₘ=Aₜ(pₐₜₘ−p₀)+ΔFₑₘ, the state space representation is of the form \dot{X}=AX+BU, where:

$$X = [ \begin{matrix}Δ x \\ v\end{matrix} ] \qquad ( 142 )$$

$$U = Δ {F}_{e m} \qquad ( 143 )$$

A state feedback U=KX is designed, yielding:

$$\dot{X} = ( A + B K ) X \qquad ( 144 )$$

where:

$$A = [ \begin{matrix}0 & 1 \\ 0 & 0\end{matrix} ] \qquad ( 145 )$$

$$B = [ \begin{matrix}0 \\ \frac{- 1}{m}\end{matrix} ] \qquad ( 146 )$$

The candidate Lyapunov function Vₚ(X)=X^{T}PX is proposed and for a system \dot{X}=A_{cl}X, where A_{cl}=A+BK, it has to satisfy:

$${V}_{p} = {X}^{T} P X > 0 , ∀ X \neq 0 \qquad ( 147 )$$

$${\dot{V}}_{p} = {X}^{T} P {A}_{c l} X + {X}^{T} {A}_{c l}^{T} P X < 0 , ∀ X \neq 0 \qquad ( 148 )$$

ph46,ph47 are satisfied if there exists a symmetric matrix P such that:

$$P > 0 \qquad ( 149 )$$

$$P {A}_{c l} + {A}_{c l}^{T} P < 0 \qquad ( 150 )$$

Replacing (144) in ph48,ph49 yields:

$$P > 0 \qquad ( 151 )$$

$$P ( A + B K ) + \qquad ( 152 )$$

Equation (152) is bilinear in the variables P and K, so a change of coordinates is made to obtain a set of linear matrix inequalities. The transformation done is:

$$Q = {P}^{- 1} \qquad ( 153 )$$

$$Y = K {P}^{- 1} \qquad ( 154 )$$

and it results in:

$$Q > 0 \qquad ( 155 )$$

$$Q$$

$$Q ( PA + P B K + {A}^{T} P + {K}^{T} {B}^{T} P ) Q < 0$$

$$QPAQ + Q P B K Q + Q {A}^{T} P Q + Q {K}^{T} {B}^{T} P Q < 0$$

$$AQ + B Y + Q {A}^{T} + {Y}^{T} {B}^{T} < 0 \qquad ( 156 )$$

The linear matrix inequalities (155) and (156) can be solved using a solver like cvx, and with ph52,ph53, the values of P and K can be found, yielding

$$P = [ \begin{matrix}0.0832 & 0.0585 \\ 0.0585 & 0.1937\end{matrix} ]$$

and K=[9.0292 29.613]. It is possible that the K obtained by solving the LMI does not guarantee continuity of the electromagnetic force, which is necessary to avoid undesired high peaks of electrical power. A modification is done so that another feasible solution of (155) and (156) is found. For that, a positive parameter kₜ is defined that will multiply the value of K. To ensure that kₜK still stabilizes the system, we define the matrix:

$$C = P A + {A}^{T} P + {k}_{t} ( P B K + {K}^{T} {B}^{T} P ) \qquad ( 157 )$$

for which we find its eigenvalues as a function of kₜ. The resulting expression for the eigenvalues of C, found using the function eig and syms from MATLAB, is:

$$eig ( C ) = [ \begin{matrix}\frac{- \sqrt{0.435 {k}_{t}^{2} - 0.25 {k}_{t} + 0.041}}{2} - 0.33 {k}_{t} + 0.059 \\ \frac{\sqrt{0.435 {k}_{t}^{2} - 0.25 {k}_{t} + 0.041}}{2} - 0.33 {k}_{t} + 0.059\end{matrix} ] \qquad ( 158 )$$

Using the function fsolve in MATLAB to find the zeroes of the expression (158), it is found that the eigenvalues are negative if kₜ>0.2868. This adds a new constraint which restricts the choice of x₃. In addition to the force continuity constraints, it is required that the velocity at the end of phase 4 is zero. In summary, the following conditions may have to be satisfied:
1. The electromagnetic force at the beginning of phase 4 must be equal to the electromagnetic force at the end of phase 3.
2. The electromagnetic force at the end of phase 4 must be zero.
3. The velocity at the end of phase 4 must be zero.

Each condition can be represented by an equation and there are three unknowns. The first two unknowns are x_{d} and kₜ that were defined previously. For the third unknown, we first define t to be such that x(t̅)=x₃ (i.e. t̅ is the switching time from phase 3 to phase 4) for the forward stroke, and then we consider an unknown v(t̅). To find the value of the three unknowns (x_{d}, kₜ and v(t̅)), the equations for the three conditions that must be satisfied are now defined. The condition for continuity of the electromagnetic force between phases 3 and 4 is:

$${F}_{em} ( \overline{t} ) = {k}_{t} K [ \begin{matrix}x ( \overline{t} ) - {x}_{d} \\ v ( \overline{t} )\end{matrix} ] + {A}_{t} ( {p}_{atm} - {p}_{0} ) \qquad ( 159 )$$

Equation (159) adds a new unknown Fₑₘ(t̅). However, because at t the controller in phase 3 is maintaining constant mechanical power, Fₑₘ(t̅) can be defined as:

$${F}_{em} ( \overline{t} ) = \frac{{p}_{d}}{v ( \overline{t} )} \qquad ( 160 )$$

given that v(t̅) is not zero. For the switching between phases 4 and 1, let [symbol] be such that x( [symbol] )=x_{f} for the forward stroke and v( [symbol] )=0. The condition for continuity of the electromagnetic force between phases 4 and 1 is:

$$0 = {k}_{t} K [ \begin{matrix}x ( ) - {x}_{d} \\ 0\end{matrix} ] + {A}_{t} ( {p}_{atm} - {p}_{0} )$$

To guarantee that v( [symbol] )=0, we can use the definition of velocity being the integral of acceleration to obtain:

$$0 - v ( \overline{t} ) = \frac{- {k}_{t} K [ \begin{matrix}x - {x}_{d} \\ v\end{matrix} ]}{m} dt = \frac{- {k}_{t} KX}{m} dt \qquad ( 162 )$$

Because the integral in equation (162) depends on both x=\dot{v} and v,

$$\frac{- {k}_{t} KX}{m} dt$$

is found by solving the set of differential equations defined by:

$$\dot{v} = \frac{- {k}_{t} KX}{m} \qquad ( 163 )$$

$$\dot{x} = v \qquad ( 164 )$$

for the interval [t̅, [symbol] ] and setting the equation:

$$\frac{- {k}_{t} KX}{m} dt = v ( ) - v ( \overline{t} ) \qquad ( 165 )$$

To guarantee that the desired value of velocity v(t̅) is obtained at the position x(t̅), the proposed approach is to tune the switching position x₂ between phase 2 and phase 3, knowing due to equations (14) that the switching positions have an effect in the dynamics of the piston. The advantage of this approach is that it does not affect the power trajectory because phases 2 and 3 are where constant power is achieved. The pseudocode to find Fₑₘ(t̅), v(t̅), x_{d} and kₜ is the following:

Algorithm to solve the unknowns in the state feedback controller includes: run phases 1 and 2, with their respective controllers. Set a value of x₂. Run phase 3 with its controller. Obtain the values of v(t̅) and Fₑₘ(t̅). With these values of v(t̅), Fₑₘ(t̅) and x( [symbol] )=x_{f} solve for x_{d} and kₜ using equations (159) and (161) and fsolve. With the values of Fₑₘ(t̅), v(t̅), x_{d} and kₜ, check equation (162). If equation (162) is not satisfied, update the value of x₂. If

$$0 - v ( \overline{t} ) > \frac{- {k}_{t} KX}{m} dt ,$$

increase x₂. If

$$0 - v ( \overline{t} ) < \frac{- {k}_{t} KX}{m} dt ,$$

decrease x₂. Run the algorithm between steps 3 and 6 until equation (162) is satisfied, and the inequality constraint on kₜ for stability is also satisfied.

It will be shown in the appendix that this algorithm converges for two particular case studies. In this problem, the states are the velocity and the position, so for each controller, white noise will be added to these values to model the measurement noise. The white noise for the velocity and the position will be denoted Wᵥ and Wₓ respectively, and they will have the following distribution:

$${W}_{v} ∼ N ( 0 , 0.05 ) \qquad ( 166 )$$

$${W}_{x} ∼ N ( 0 , 0.005 ) \qquad ( 167 )$$

where the values of 0.05 and 0.005 are the hundredth of the difference of the range of the velocity (between 0 and 5 m/s) and the position (between 0.15 m and 0.63 m), respectively. The values of noise will be added in each controller in the equations where the measurements of velocity and position are required, yielding:

$${v}_{n} = v + {W}_{v} \qquad ( 168 )$$

$${x}_{n} = x + {W}_{x} \qquad ( 169 )$$

and these new values of velocity and position are the ones used to determine the electromagnetic force at each instant, for each controller. The behaviour of the controllers when noise is added are studied in the following.

The simulations were conducted on MATLAB R2020B on a Dell Inspiron 14 5000 with a processor Interl Core 7. The input parameters are seen in Table 2.

TABLE 2
Table showing parameters of the dynamics of the expander.

| | |
|---|---|
| γ | 1.33 |
| p₀(atm) | 6 |
| d(m) | 0.08 |
| m(kg) | 19 |
| x₀(m) | 0.15 |
| xₚₕₐₛₑ₁₋₂ = | 0.16 |
| x₁(m) | |
| xₚₕₐₛₑ₂₋₃ = | 0.55 |
| x₂(m) | |
| xₚₕₐₛₑ₃₋₄ = | 0.6 |
| x₃(m) | |
| x_{f}(m) | 0.63 |
| P_{d}(W) | 1000 |
| Desired max. | 5 |
| v(m/s) | |

TABLE 3
Table showing parameters for the simulation of the mechanical power

| | |
|---|---|
| q(Opt.Cont) | 1 |
| r(Opt.Cont) | 1 or 1000 |
| Sample time (MPC and NN) | $\frac{{t}_{l} - {t}_{i}}{100}$ |
| Prediction horizon (MPC) | 100 |
| Control horizon (MPC) | 100 |
| aₙ, bₙ, cₙ, β (NN) | 0.0937, 0.5, 0.4588, 0.01 |

For the conditions of tables 2 and 6, the control laws for each controller are calculated by using the equations above. More specifically, the design equations are as follows: open loop in phase 1 using sollin1,sollin2,sollin3 yield M=52526. Neural network in phases 2 and 3 for which the optimization problem (60) gives:

$$\overline{Z} = [ \begin{matrix}2.303 * {10}^{- 8} & - 8.862 * {10}^{- 6} & 5.855 * {10}^{- 5} & 1.6 * {10}^{- 5} \\ - 8.862 * {10}^{- 6} & - 6.835 * {10}^{- 4} & 0.0267 & 0.4903 \\ 5.855 * {10}^{- 5} & 0.0267 & 0.0434 & - 0.2394 \\ - 1.6 * {10}^{- 5} & 0.4903 & - 0.2394 & 0.214\end{matrix} ]$$

Optimal continuous time controller in phases 2 and 3, the two-boundary value problem from boun1,boun2,boun3,boun4,boun5,boun6,boun7,boun8 were solved using the collocation method Use A, obtained from the collocation method in equation (90) to define Fₑₘ.

Model predictive controller in phases 2 and 3, the functions nlmpc and nlmpcmove to solve the optimization problem (119) with constraints (124), (125), (128), (129), (130), (131), (132), (133), (137), and (138) to obtain the trajectories of P and Fₑₘ.

The state feedback in phase 4 is obtained by solving LMIs (155), (156) and conditions (161) and (159) yield kₜ=1.5, K=[13.52 44.35] and x_{d}=−187.7 for the neural network and kₜ=3.68, K=[33.2 108.89] and x_{d}=−76.07 for the other 2 controllers.

To see the behaviours of the four controllers under different initial conditions, two parameters are evaluated: the switching position x₁ and the initial gas pressure p₀. To ensure that the desired final position is achieved with v=0, the switching position x₂ is also changed. All the conditions on the parameters can be seen in tables 4 and 5.

TABLE 4
Table showing initial conditions for switching
positions. p₀ is always 6 atm

| Condition | x₁ (m) | x₂ (m) |
|---|---|---|
| C1 | 0.16 | 0.55 |
| C2 | 0.18 | 0.51 |
| C3 | 0.2 | 0.47 |
| C4 | 0.22 | 0.45 |
| C5 | 0.24 | 0.42 |

TABLE 5
Table showing initial conditions for initial
gas pressures. x₁ is always 0.16 m

| | Pressure | x₂ |
|---|---|---|
| Condition | (atm) | (m) |
| C1 | 6 | 0.55 |
| C6 | 4 | 0.39 |
| C7 | 8 | 0.52 |
| C8 | 10 | 0.49 |
| C9 | 12 | 0.48 |

Finding the electrical power requires knowing diverse parameters of the linear expander. A model with the parameters described in table 6 is used.

TABLE 6
Table showing generator parameters

| Parameters | Value |
|---|---|
| K_{f} Force | 87.8 |
| $coefficient ( \frac{N}{A} )$ | |
| R Resistor (ohm) | 0.236 |
| L Inductance (H) | 0.005 |
| Kᵥ Velocity | 58.54 |
| $coefficient ( \frac{Vs}{m} )$ | |

Each controller (neural network, continuous-time optimal and model predictive) will be evaluated. First, the mechanical and electrical power is determined under the same initial parameters. Then, the controllers will be evaluated under different conditions of position and pressure. Also, the effect of noise is evaluated on these controllers. Later, the results will be compared between them, including different initial parameters and noise. Lastly, the supercapacitor is implemented to see its effect on the electrical power in the instant of change from the forward to the return stroke.

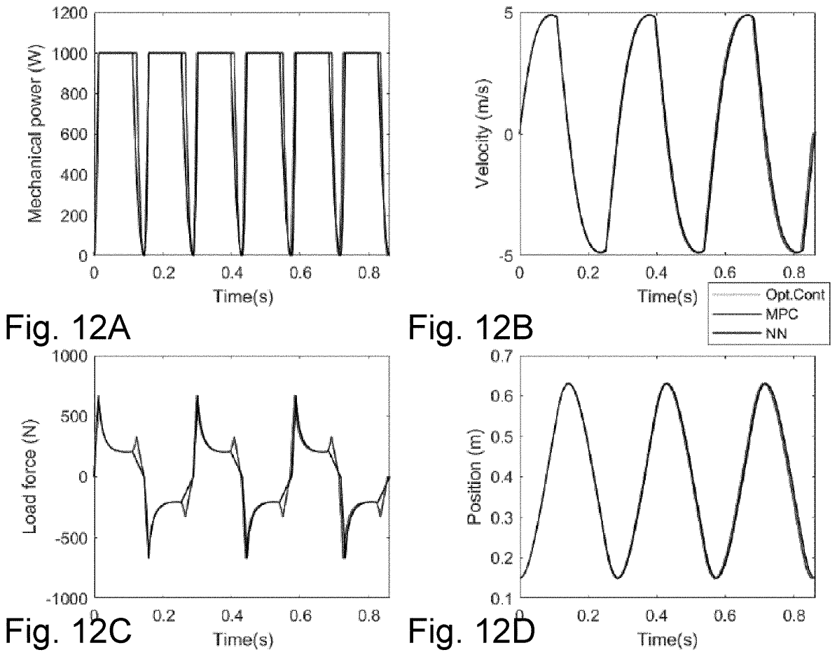

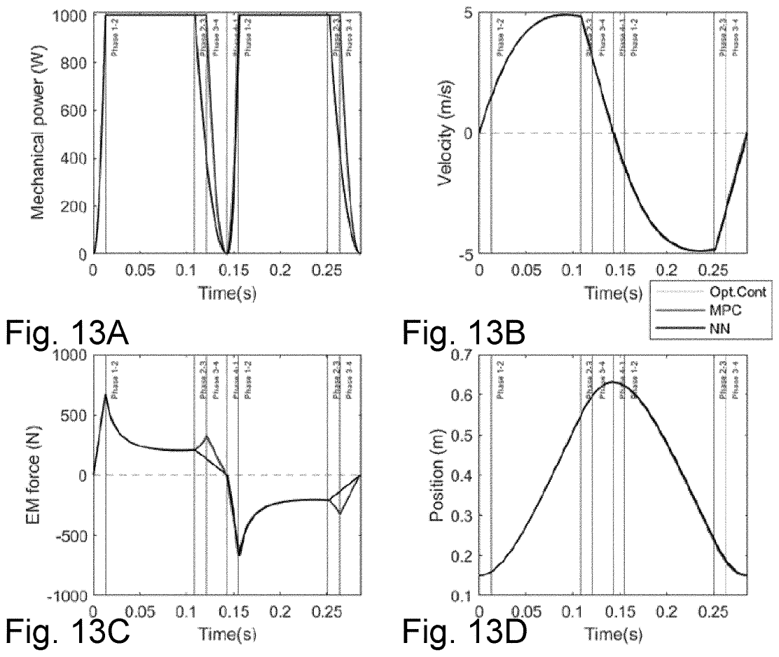

FIGS. 12A-D and FIGS. 13A-D show the results of using the three controllers using the parameters shown in table 2 and an unit value of r for the optimal control. NN represents the first controller discussed above, Opt.Cont represents the second controller and MPC represents the third controller from above. Each controller obtained constant power during the isentropic expansion for the forward and the return part the power during the isentropic expansions, with a difference between them of less than 1% of the value of the desired power. The graphs for velocity, electromagnetic force and position overlap each other for the optimal continuous time and the model predictive controllers.

The prediction of the neural network gives trajectories close to the other two controllers, especially in the beginning of phase 2, but as the piston continues to move and enter phase 3, the prediction is not as accurate as before, and the controller does not predict the same drop in the velocity as the other controllers. That explains the difference in the force trajectories. The solution is to move the switching position x₃ to x₂, so a lower value of velocity can be obtained before the beginning of phase 4. That is the reason of the different values of kₜ and x_{d} for the control laws for phase 4.

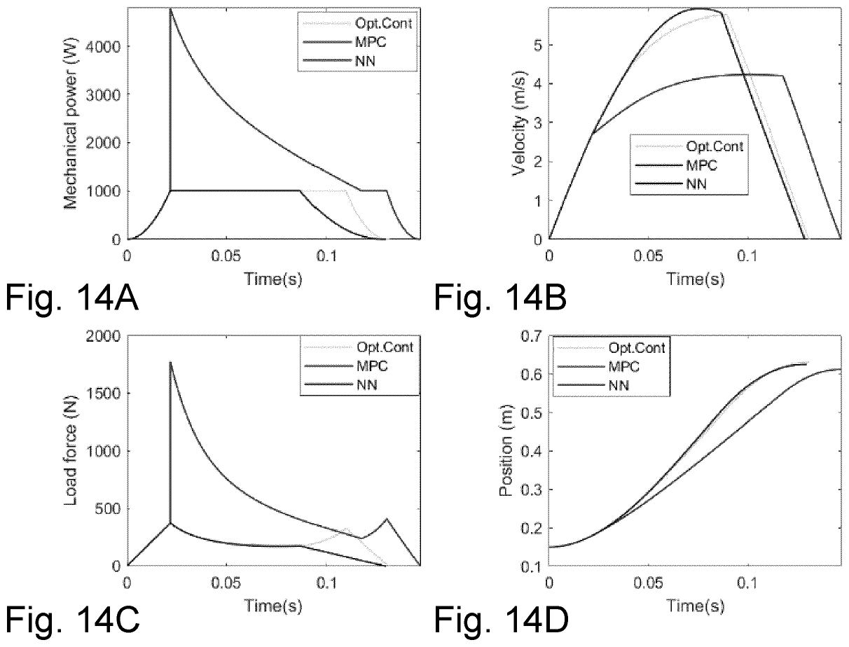

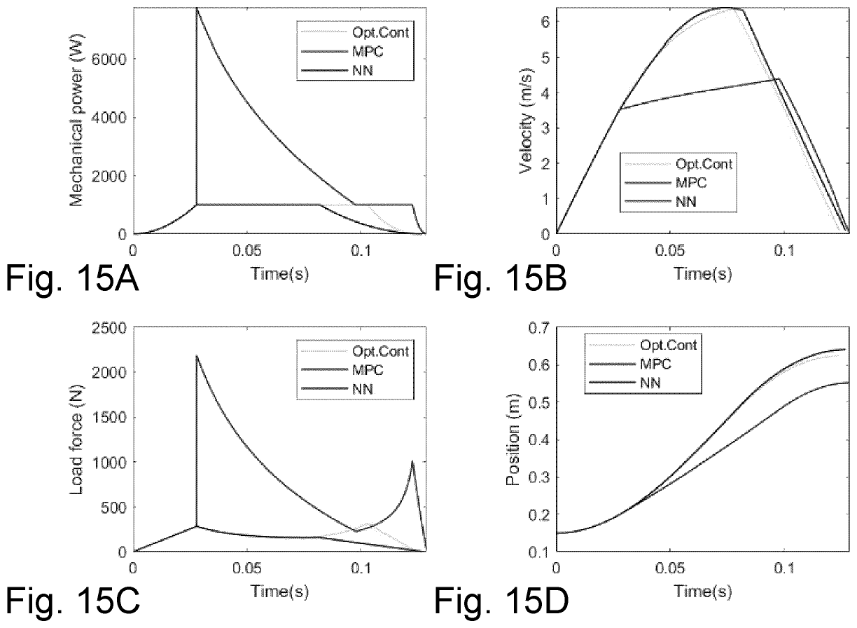

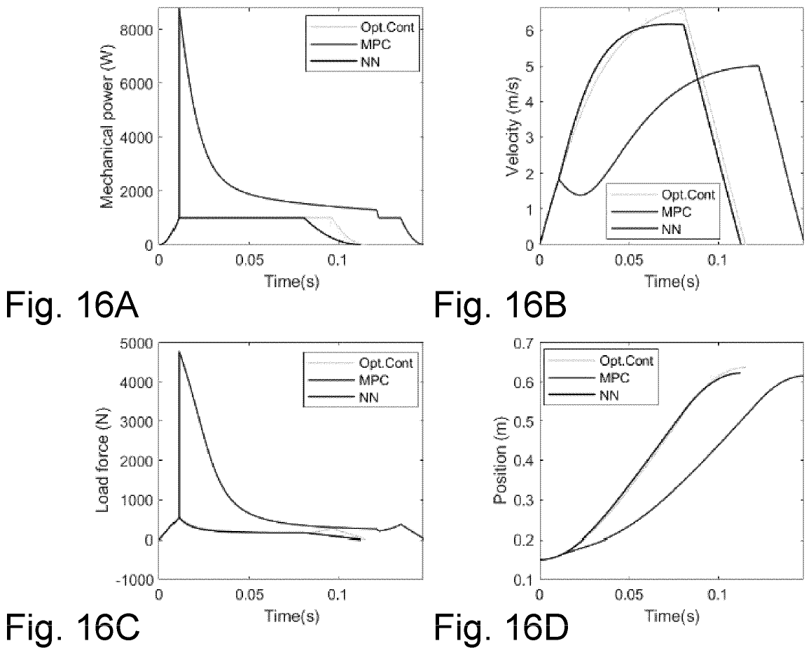

The three methods analyzed gave similar results because the optimal trajectory for the given initial conditions on table 2 satisfied with the constraints, so it is important to check how they would react under different conditions that could not satisfy the constraints. These results can be seen in FIGS. 14A-D, FIGS. 15A-D and FIGS. 16A-D for conditions C2, C3 and C7, respectively. The control laws for these conditions can be found in the appendix. The prediction from the neural network is configurated so its focus is to obtain constant power, so that is the reason why its trajectories are closer to the optimal continuous time model than the MPC one. It is important to add that while the results are not the same, the trajectories are similar between the neural network controller and the optimal continuous time controller, validating the use of quadratic neural networks. The optimal discrete model, which involves hard constraints, is the only one that satisfied the constraints and the value of velocity never surpasses the maximum value. In the optimal continuous time model, even when the value of r is changed to 1000, this was not sufficient to reduce the velocity to the desirable range of values. It could exist a value of r that would make the system to never surpass the velocity, but it is expected to be a very high value, due to the low effect of r in the results. It is important to add that while the closed loop system satisfied the constraints, the model predictive controller was the one that was farther from the desired power, compared to the other two. Also, the high electromagnetic force required to satisfy the constraints does not result in the same final position as when the optimal continuous time controller is used. The appendix shows the mechanical results of the MPC when the constraint on the maximum velocity is relaxed to 10 m/s and as expected, the results are similar to the ones from the other controllers.

TABLE 7
Table showing simulation time for phase 2 for
all controllers at different initial conditions

| Condition | NN | Opt. Cont. | | MPC | |
|---|---|---|---|---|---|
| C1 | 0.0712 s | 0.0049 | s | 13.6 | s |
| C2 | 0.0053 s | 0.0047 | s | 7.25 | s |
| C3 | 0.0051 s | 0.0028 | s | 12.31 | s |
| C7 | 0.0052 s | 0.004 | s | 7.21 | s |

Table 7 shows the time the simulation takes to determine the trajectories of phase 2. The model predictive controller was consistently the one that took more time in finding the trajectories, by multiple orders of magnitude. The results show how for this operation the model predictive controller is not feasible to implement in real time, because the simulation takes longer than then system is running.

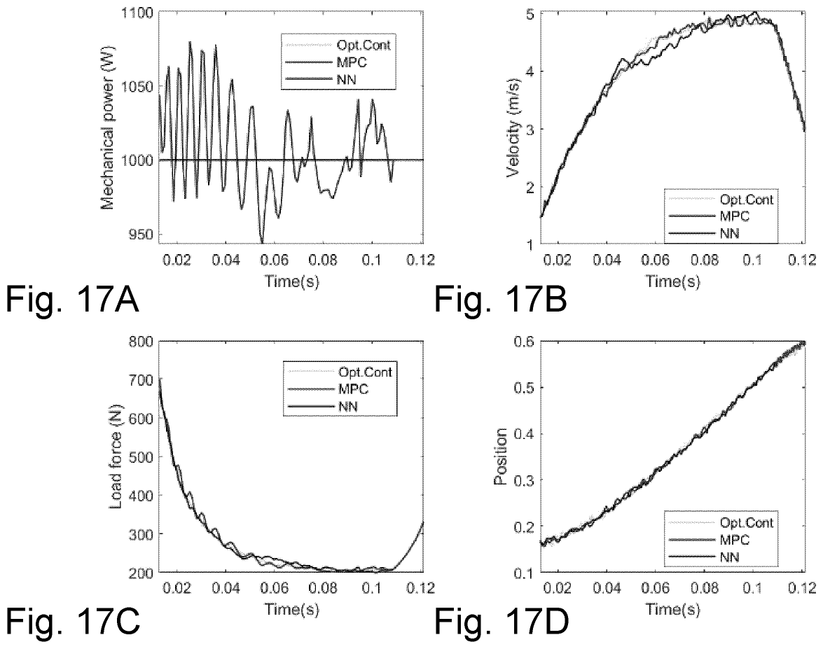

FIGS. 17A-D show the results for all three controllers with the addition of noise. The results are very similar between them, showing that the noise does not cause a significant effect for the neural network, compared with the other controllers, and validating its use to predict trajectories. An advantage of the neural network is that the variation of power is less than in the MPC controller. The appendix has the graphs for every controller at all initial conditions from Tables 6 and 7, and for other results with noise.

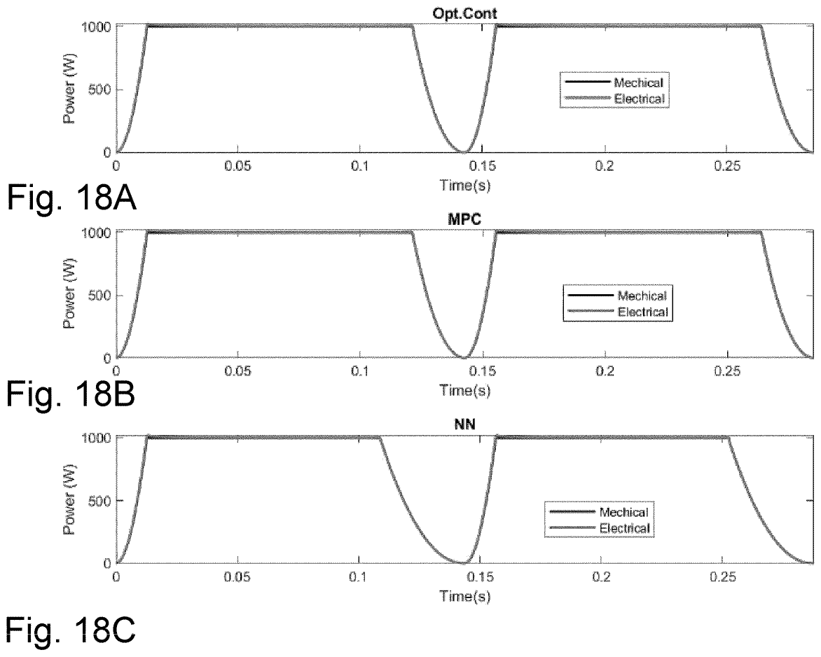

For the next results, the parameters used are the same ones from C1. FIGS. 18A-D shows the results of the simulation for the mechanical and electrical power after one cycle for all controllers. None of the controllers evaluated presented an undesired behaviour and the electrical power follows closely the mechanical power, different from the small overshoot in the beginning.

The piston has to change its direction, from moving forward to backward, to complete a full cycle. During the phases involving this process (phase 4 and the phase 1 for the new half of a cycle), the output power drops until it reaches zero at the switching instant of the phases that were previously mentioned. To reduce this mandatory drop, a supercapacitor is used to store energy and release it when the energy is below the desired value. Supercapacitors were selected over batteries because they have a higher rate of charging and discharging, which is better suited for the linear expander due to the short time of phase 4 and phase 1, and the high frequency at which the piston will be moving.

The controller is modified so the new setpoint power is greater than the desired value. This new increased setpoint is selected under the designer's criteria. The excess power will go to the circuit that includes the supercapacitor. The voltage obtained from the linear generator has a higher value than most supercapacitors can support, so a transformer is used to reduce the voltage to a value in the range of operation of the supercapacitor. In this case, the supercapacitor's limit voltage is 16V. Additionally, the supercapacitors can only store energy if they are in a DC circuit. Due to the cyclic nature of the generator, it behaves like an AC circuit, so a diode bridge is used after the transformer.

The switch in FIG. 19 will change from the obtained voltage to zero depending on the output power: if the power is above the desired value, the switch will use the voltage from the linear generator and the current flowing through a resistor to charge the supercapacitor; if the power goes below that value, the voltage becomes zero and the supercapacitor will become a generator of power instead of a consumer. The series circuit that includes a resistor and a supercapacitor can been in FIG. 19. The equations used for the selection of the resistance R and the capacitance C are:

$$V ( t ) = RC {\dot{V}}_{C} ( t ) + {V}_{C} ( t ) \qquad ( 170 )$$

$$I ( t ) = C {\dot{V}}_{C} ( t ) \qquad ( 171 )$$

When V(t) is zero (discharge process), it yields:

$$0 = RC {\dot{V}}_{C} ( t ) + {V}_{C} ( t ) \qquad ( 172 )$$

$${V}_{C} ( t ) = {V}_{0} ( {e}^{\frac{- t}{RC}} ) \qquad ( 173 )$$

$$I ( T ) = \frac{{V}_{0}}{R} ( {e}^{\frac{- t}{RC}} ) \qquad ( 174 )$$

$${P}_{C} ( t ) = {V}_{C} ( t ) I ( t ) \qquad ( 175 )$$

where V₀ is the initial voltage of the supercapacitor when the discharge process begins and V_{c} is the voltage on the capacitor. Based on eq:rcdescarga1,eq:rcdescarga2,eq:rcdescarga3,eq:rcdescarga4, a high value of RC, also called the time constant, can reduce the power drop in time. However, it could generate high energy loss in the charging process, which has to be evaluated numerically using eq:rcinicial1,eq:rcinicial2.

TABLE 8
Table showing parameters for the simulation of the ESS

| | |
|---|---|
| NewP_{d}(W) | 1350 |
| C(F) | 0.32 |
| R(Ω) | 0.14 |

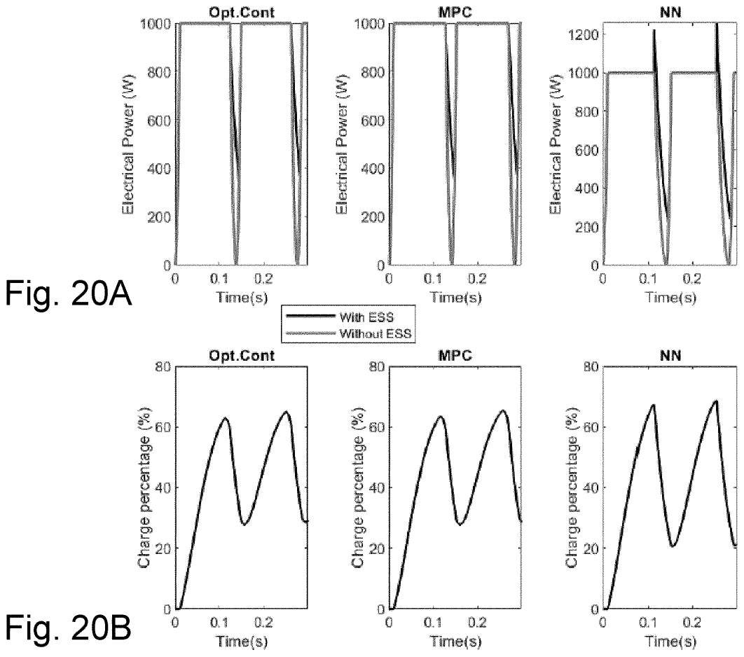

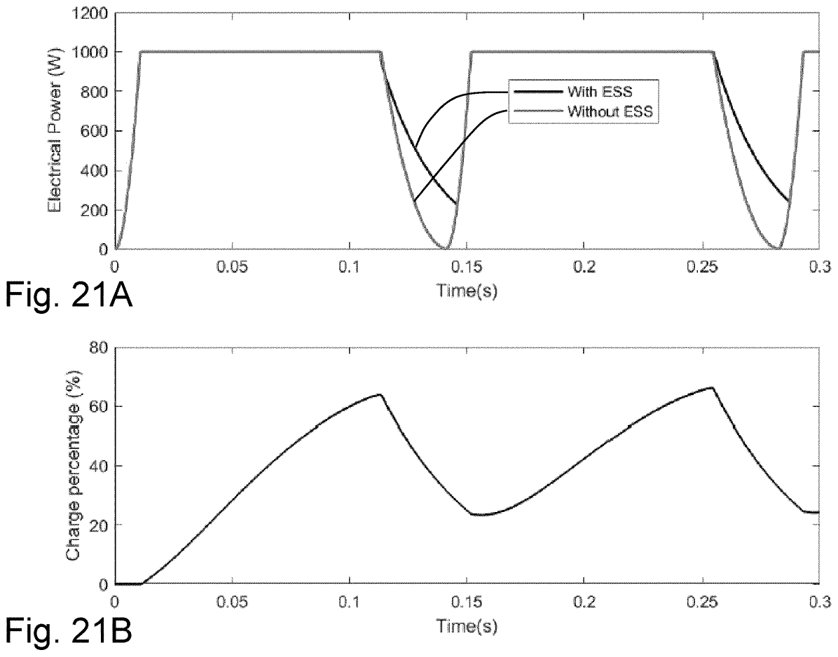

It can be seen in FIG. 20 that the charge of the supercapacitor does not surpass the 100%. Also, it is seen that the drop in the power is lower when the supercapacitor is used compared to when it is not. The value of the energy obtained using supercapacitor during the period where the energy is lower than the designed value is 44.3% higher than the value at the same interval and without using the supercapacitor. While the optimal continuous time and the model predictive controllers have similar electrical results after using the supercapacitor, the result for the quadratic neural network model using the same supercapacitor has an initial peak at the beginning of the discharge process. To remove those peaks, one modification was to change the value of the resistor to 0.16Ω. The result is in FIG. 21.

From the work performed in this example the following conclusions can be drawn, as presented in the next paragraphs.

A switched control system was successfully designed for a free-piston linear expander, in which constant power was achieved during the isentropic expansion (phases 2 and 3) by three different approaches.

The piston could successfully initialize movement, obtain constant power and stop in the desired range.

A quadratic neural network is implemented to control the power in a free-piston linear expander, with the results being an advance in the use of quadratic neural network for predicting and controlling power systems.

The closed loop system using a neural network exhibits similar behavior to the closed loop results obtained with the other controllers, especially for phase 2, as seen in FIG. 12, FIG. 14, FIG. 15, FIG. 16 and FIG. 17.

Even with noise, the results using neural networks are close to the trajectories without noise, and to the results using other controllers, with and without noise.

The neural network does not require knowledge about the model to predict the trajectories and control the output.

When compared to the optimal continuous time controller, the neural network controller is a simpler solution because in the former, the collocation method is used between two phases, and therefore the values of the states and costates must be known at the switching position x_2 so the collocation method can be applied to find the trajectories for phase 2 and phase 3. This could require some trial and error, which is not the case for the neural network.

The proposed neural network solves a quadratic convex problem, always guaranteeing a global optimal solution. Therefore, the implementation is simply the calculation of a quadratic form followed by a quotient. In contrast, there is the possibility that the command fmincon used in the MPC algorithm in Matlab does not find a global solution due to the non-convexity of the optimization and the nonlinearity of the dynamics. The complexity of the system increases the time that the software takes to find a solution, reducing the feasibility of a real-time implementation compared with the neural network as seen in table 9. However, the MPC guarantees that the velocity constraints are satisfied whereas the neural network does not.

The use of the high pressure chamber in phase 3 helped to reduce the velocity so the state feedback controller uses less power to stop the piston.

The ESS can help to reduce the drop of power due to the change of stroke but it requires an adequate determination of the parameters of the supercapacitor, so that the system does not incur an excessive loss of power during the charging process.

As can be understood, the examples described above and illustrated are intended to be exemplary only. For instance, in an aspect, there is described an electric power generating apparatus comprising: a free-piston linear expander having a moving shaft creating mechanical power; an electrical generator converting the mechanical power into electrical power; a variable frequency drive configured for applying an electromagnetic load force modifying a movement of the shaft; and a controller communicatively coupled to the variable frequency drive, the controller configured to perform the steps of: receiving sensor data including a first shaft position value, a first shaft velocity value, and a first electromagnetic load force value; using a drive control module, determining, based on the sensor, a second electromagnetic load force value which when applied would cause a shaft velocity to gradually change to a second shaft velocity value; and applying the second electromagnetic load force value, the second electromagnetic load force value and the second shaft velocity value causing an output power value to correspond to a desired output power value. In another aspect, there is described an electric power generating apparatus having a free-piston linear expander having a moving shaft creating mechanical power; an electrical generator converting the mechanical power into electrical power; a variable frequency drive configured for applying an electromagnetic load force modifying a movement of the shaft; and a controller communicatively coupled to the variable frequency drive, the controller configured to perform the steps of: receiving sensor data including a first shaft position value, a first shaft velocity value, and a first electromagnetic load force value; using a velocity determination module, and based on the sensor data, determining a second shaft velocity value causing a second output power value to correspond to a desired output power value; determining a second electromagnetic load force modifying the movement of the shaft to match the second shaft velocity value; and instructing the variable frequency drive to apply the second electromagnetic load force. The scope is indicated by the appended claims.

What is claimed is:

1. An electric power generating apparatus comprising:
a free-piston linear expander having a moving shaft creating mechanical power;
an electrical generator converting the mechanical power created by movement of the shaft into electrical power;
a variable frequency drive coupled to the electrical generator, the variable frequency drive configured for applying an electromagnetic load force u(t) modifying the movement of the shaft and said electrical power; and
a controller communicatively coupled to the variable frequency drive, the controller configured to perform the steps of:
receiving sensor data reflecting operating conditions of the electric power generating apparatus at a first moment in time tᵢ, the sensor data including a first shaft position value x(tᵢ), a first shaft velocity value v(tᵢ), and a first electromagnetic load force value u(tᵢ);
using a drive control module, determining, based on the sensor data at the first moment in time tᵢ, a second electromagnetic load force value u(tᵢ₊₁) which when applied until a second moment in time tᵢ₊₁ would cause a shaft velocity v(t) to gradually change to a second shaft velocity value v(tᵢ₊₁) at the second moment in time tᵢ₊₁, the second electromagnetic load force value u(tᵢ₊₁) and the second shaft velocity value v(tᵢ₊₁) causing an output power value P(tᵢ₊₁) at the second moment in time tᵢ₊₁ to correspond to a desired output power value Pd(tᵢ₊₁); and
instructing the variable frequency drive to apply the second electromagnetic load force value u(tᵢ₊₁) until the second moment in time tᵢ₊₁.

2. The electric power generating apparatus of claim 1 wherein the drive control module has been trained using a neural network.

3. The electric power generating apparatus of claim 2 wherein the neural network is a quadratic neural network.

4. The electric power generating apparatus of claim 1 wherein a velocity trajectory function or look-up table is pre-determined using a velocity determination module, the velocity determination module associating a plurality of second shaft velocity values v(tᵢ₊₁) to a plurality of combinations of first shaft position values x(tᵢ), first shaft velocity values v(tᵢ), and first electromagnetic load force values u(tᵢ).

5. The electric power generating apparatus of claim 1 wherein the desired output power value Pd(tᵢ₊₁) corresponds to a first output power value P(tᵢ) representative of an output power value of the electric power generating apparatus at the first moment in time tᵢ.

6. The electric power generating apparatus of claim 1 wherein said steps of receiving sensor data, determining the second electromagnetic load force value u(tᵢ₊₁) and applying the second electromagnetic load force value u(tᵢ₊₁) are performed after the first moment in time tᵢ and before the second moment in time tᵢ₊₁.

7. The electric power generating apparatus of claim 6 wherein said steps are performed in less than 1 ms, preferably less than 0.5 ms, and most preferably less than 0.1 ms.

8. The electric power generating apparatus of claim 1 wherein the free-piston linear expander has a path, the shaft extending along the path, a piston mounted to the shaft, and a cylinder enclosing the piston and forming a hermetically sealed chamber which upon expansion of pressurized gas contained therein moves the shaft along the path thereby creating the mechanical power.

9. The electric power generating apparatus of claim 1 wherein the electrical generator is a linear electrical generator having a plurality of permanent magnets mounted to the shaft and a plurality of coils magnetically coupled to the plurality of permanent magnets and looped around the shaft.

10. The electric power generating apparatus of claim 1 wherein the electrical generator includes a converting device converting the mechanical power of a linear movement of the shaft into rotary movement.

11. The electric power generating apparatus of claim 10 wherein the electrical generator includes a rotor mounted to the converting device and a stator magnetically coupled to the rotor.

12. The electric power generating apparatus of claim 1 further comprising an energy storage device coupled to the electric power generating apparatus, the energy storage device storing electrical power and one of receiving and delivering a portion of said electrical power when required by the controller.

13. The electric power generating apparatus of claim 12 wherein the controller performs said one of said receiving and said delivering upon determining that a difference exists between the desired output power value Pd(tᵢ₊₁) at the second moment in time tᵢ₊₁ and the output power value of the electric power generating apparatus at the second moment in time tᵢ₊₁.

14. A method of operating an electric power generating apparatus, the electric power generating apparatus having a free-piston linear expander having a moving shaft generating mechanical power, an electrical generator converting the mechanical power into electrical power, a variable frequency drive coupled to the electrical generator and configured for applying an electromagnetic load force u(t) to the electric power generating apparatus, the method comprising:
using a controller communicatively coupled to the variable frequency drive, the controller configured to perform the steps of:
receiving sensor data reflecting operating conditions of the electric power generating apparatus at a first moment in time tᵢ, the sensor data including a first shaft position value x(tᵢ), a first shaft velocity value v(tᵢ), and a first electromagnetic load force value u(tᵢ);
using a drive control module, determining, based on the sensor data at the first moment in time tᵢ, a second electromagnetic load force value u(tᵢ₊₁) which when applied until a second moment in time tᵢ₊₁ would cause a shaft velocity v(t) to gradually change to a second shaft velocity value v(tᵢ₊₁) at the second moment in time tᵢ₊₁, the second electromagnetic load force value u(tᵢ₊₁) and the second shaft velocity value v(tᵢ₊₁) causing an output power value P(tᵢ₊₁) at the second moment in time tᵢ₊₁ to correspond to a desired output power value Pd(tᵢ₊₁); and
instructing the variable frequency drive to apply the second electromagnetic load force value u(tᵢ₊₁) until the second moment in time tᵢ₊₁.

15. The method of claim 14 wherein the drive control module has been trained using a neural network.

16. The method of claim 15 wherein the neural network is a quadratic neural network.

17. The method of claim 14 wherein the desired output power value Pd(tᵢ₊₁) corresponds to a first output power value P(tᵢ) representative of an output power value of the electric power generating apparatus at the first moment in time tᵢ.

18. The method of claim 14 wherein said steps of receiving sensor data, determining the second electromagnetic load force value u(tᵢ₊₁) and applying the second electromagnetic load force value u(tᵢ₊₁) are performed after the first moment in time tᵢ and before the second moment in time tᵢ₊₁.

19. The method of claim 18 wherein said steps are performed in less than 1 ms, preferably less than 0.5 ms, and most preferably less than 0.1 ms.

20. An electric power generating apparatus comprising:
a free-piston linear expander having a moving shaft creating mechanical power;
an electrical generator converting the mechanical power into electrical power;
a variable frequency drive configured for applying an electromagnetic load force modifying a movement of the shaft; and
a controller communicatively coupled to the variable frequency drive, the controller configured to perform the steps of:
receiving sensor data including a first shaft position value, a first shaft velocity value, and a first electromagnetic load force value;
using a drive control module, determining, based on the sensor, a second electromagnetic load force value which when applied would cause a shaft velocity to gradually change to a second shaft velocity value, the second electromagnetic load force value and the second shaft velocity value causing an output power value to correspond to a desired output power value; and
applying the second electromagnetic load force value.
